(19) United States
(12) Patent Application Publication
(10) Pub. No.: US 2009/0084311 A1
(43) Pub. Date: Apr. 2, 2009

(54) LIQUID APPLICATION APPARATUS AND INKJET RECORDING APPARATUS

(76) Inventors: Junichi Yoshida, Kanagawa-ken (JP); Hiroshi Uemura, Kanagawa-ken (JP); Seiichi Inoue, Kanagawa-ken (JP)

Correspondence Address: BIRCH STEWART KOLASCH & BIRCH, PO BOX 747, FALLS CHURCH, VA, 22040-0747, US

(21) Appl. No.: 12/239,668

(22) Filed: Sep. 26, 2008

(30) Foreign Application Priority Data
Sep. 28, 2007 (JP) 2007-256769

(51) Int. Cl. B05C 11/04

(52) U.S. Cl. 118/46

(57) ABSTRACT

A liquid application apparatus applies application liquid onto a band-shaped base material that is conveyed continuously. The liquid application apparatus includes: an application cylinder which includes an application section and two small diameter sections having a diameter smaller than the application section, the two small diameter sections being arranged so as to interpose the application section, the application section having an upper portion that is in contact with the band-shaped base material and a lower portion at which the application liquid is supplied, the supplied application liquid on the application section being transferred to the band-shaped base material at the upper portion of the application section while the application cylinder is rotated; a first blade which makes contact with a circumferential surface of the application section of the application cylinder at a contact line, the first blade scraping away an excess of the application liquid on the application section of the application cylinder before the application liquid is transferred to the band-shaped base material; and a second blade which is in contact with circumferential surfaces of the two small diameter sections of the application cylinder.

### BACKGROUND OF THE INVENTION

1. Field of the Invention

The present invention relates to a liquid application apparatus and inkjet recording apparatus, and more particularly, to technology for improving application faults, such as application non-uniformities and overflow of liquid onto the rear surface of the base material, in a liquid application apparatus (e.g., a gravure roller) in which liquid having been applied in excess onto the surface of a round application cylinder is scraped off by means of a blade to achieve a prescribed application volume and then applied to a base material.

2. Description of the Related Art

An inkjet recording method has been known which performs recording by ejecting droplets of ink respectively from a plurality of ejection nozzles which are formed in an inkjet head. This type of method has been used widely since it enables images of high quality to be recorded on recording media of a wide variety of types, while achieving low running costs and producing little noise during the recording operation.

Furthermore, an inkjet recording method has also been known which is a two-liquid method for promoting fixing of ink by forming an ink image by causing reaction of two liquids, namely, an ink and a treatment liquid which aggregates the ink.

In an inkjet recording method, intermediate transfer methods have been investigated in the related art, with the object of achieving good image formation onto recording media of various types, and in particular, a method which applies an undercoating liquid (treatment liquid) such as an ink aggregating agent, to an intermediate transfer body is suitable for forming images. When forming an image on a cut paper using this system, reverse rolling application using a gravure roller is a suitable method, since it applies a film of undercoating liquid which has a uniform thickness.

A liquid application apparatus based on a gravure roller system is composed in such a manner that liquid that has been applied in excess on the surface of a gravure roller is scraped off to achieve a prescribed application volume by means of a doctor blade (hereinafter, simply called a “blade”), and the liquid is then applied to a base material (for example, Japanese Patent Application Publication No. 2006-95489).

However, in the case of a liquid application apparatus of this kind, a portion of the treatment liquid which has been scraped off by the blade wets and spreads in the width direction of the blade, the application thickness at either end portion of the base material becomes thicker than in the central portion (application non-uniformity arises), and the application apparatus becomes soiled due to liquid flowing over onto the rear surface of the base material. In particular, in recent years, high-speed printing has been demanded in inkjet recording apparatuses, and hence it is imperative to increase the application speed at which treatment liquid is applied to the base material. With high-speed application, the amount of treatment liquid scraped off by the blade is increased, and therefore application non-uniformities and overflow to the rear side becomes more liable to occur, and therefore improvement in these respects is needed urgently.

Japanese Patent Application Publication No. 5-220430 discloses an application apparatus in which a coating material is supplied to the surface of an application roller (gravure roller), surplus coating material is scraped away by a blade and the material is then applied to a base film, covers being provided at positions on the application roller corresponding to the respective end portions of the blade, and being composed so as not to rotate. By this means, even if the coating material which is scraped off by the blade during the application of the coating material accumulates at either end portion of the blade, it does not bleed out, scatter or solidify at the respective end sections of the blade, but rather, can be made to drop off in a downward direction.

Nevertheless, if the application roller is rotated at high speed in order to apply an application liquid quickly, then the amount of the application liquid which is scraped off by the blade and which wets and spreads in the breadthways direction of the blade increases, and, as described in Japanese Patent Application Publication No. 5-220430, it is difficult sufficiently to prevent thicker application in the end portions of the base material, or overflow of liquid to the rear surface of the base material, by adopting a method which provides a pair of covers at positions on the application roller corresponding to the respective end sections of the blade. In particular, in the case of an inkjet recording apparatus, the treatment liquid often contains surfactant, and if the application roller is rotated at high speed then the treatment liquid is liable to foam and the treatment liquid becomes less liable to be held (retained) in the cells which are formed in the surface of the roller. By this means, inadequate retention of treatment liquid on the roller is liable to occur. As a measure for preventing foaming, it is necessary to increase the supply of liquid to the liquid receiving pan in order to suppress the creation of foam or to increase the amount of liquid which is applied to the gravure roller. However, this means increasing the amount of liquid which is scraped off by the blade, and therefore the amount of treatment liquid which wets and spreads increases. As a result of this, thicker application in the respective end portions of the base material and overflow of liquid to the rear surface of the base material become even more liable to occur.

Furthermore, the method described in Japanese Patent Application Publication No. 5-220430 gives rise to new drawbacks such as the following, due to the components such as the covers. In other words, since the blade makes contact simultaneously with three components, namely, the application roller and the pair of covers, and the amount of liquid scraped off by the blade is instable, then the accuracy of the thickness of the liquid applied to the base material tends declines. The accuracy of the application thickness is especially liable to become instable in the case of high-speed application where the application roller is rotated at high speed.

As a countermeasure to this, in Japanese Patent Application Publication No. 5-220430, grooves of the same width and same thickness as the covers are formed in the surface of the application roller in order to eliminate steps between the surface of the application roller and the surfaces of the covers. However, for this purpose, highly accurate processing is required in both the application roller and the covers, and depending on the circumstances, surface polishing may be necessary in order to remove the steps after the covers have been fitted into the grooves, and therefore extremely complicated processing steps are required. Furthermore, if a gap is created when the cover is fitted into the groove, then the coating material will enter into this gap and dry and solidify there, and this solidified material not only has an adverse effect on coating accuracy, but also impedes the smooth rotation of the application roller.

Furthermore, although miniature blades are provided on the inner surfaces of the covers, since they are positioned opposing the blade, then it becomes harder to make the coating material that has been scraped off by the blade fall off in the downward direction, and the coating material is liable to accumulate and solidity on the miniature blades.

Furthermore, Japanese Patent Application Publication No. 5-220430 describes composing the covers in such a manner that the end portions in the breadthways direction of the base film are raised up. By this means, it may be possible to envisage beneficial effects in preventing soiling at the respective end sections of the base film (the sections where liquid is not applied); however, if the base film has high rigidity, then the adhesion between the base film and the application roller becomes poor and there is a risk of decline in the accuracy of liquid application, as well as a risk of damage to the respective end portions of the base film.

In this way, the application apparatus according to Japanese Patent Application Publication No. 5-220430 does not provide satisfactory prevention of the occurrence of thicker application at the respective end portions of the base material or prevention of the overflow of liquid to the rear surface of the base material during high-speed application, and moreover, there is a possibility that application accuracy declines due to components (i.e., a pair of covers) provided. Hence, further improvements are required.

### SUMMARY OF THE INVENTION

The present invention has been contrived in view of these circumstances and provides a liquid application apparatus and an inkjet recording apparatus which uses this liquid application apparatus, whereby even in cases where an application liquid is applied at high speed, it is possible reliably to prevent a portion of the treatment liquid scraped off by a first blade from wetting and spreading in the breadthways direction of the blade, thereby preventing the liquid from being applied more thickly in the respective end portions of the base material than in the central portion thereof, or preventing the liquid from flowing over onto the rear surface of the base material, and whereby components which are provided for this purpose can be prevented from having an adverse effect on the accuracy of application and the like.

In order to attain the aforementioned object, the present invention is directed to a liquid application apparatus which applies application liquid onto a band-shaped base material that is conveyed continuously, the liquid application apparatus comprising: an application cylinder which includes an application section and two small diameter sections having a diameter smaller than the application section, the two small diameter sections being arranged so as to interpose the application section, the application section having an upper portion that is in contact with the band-shaped base material and a lower portion at which the application liquid is supplied, the supplied application liquid on the application section being transferred to the band-shaped base material at the upper portion of the application section while the application cylinder is rotated; a first blade which makes contact with a circumferential surface of the application section of the application cylinder at a contact line, the first blade scraping away an excess of the application liquid on the application section of the application cylinder before the application liquid is transferred to the band-shaped base material; and a second blade which is in contact with circumferential surfaces of the two small diameter sections of the application cylinder.

In this aspect of the present invention, even if the application liquid is not scraped away completely by the first blade and wets and spreads in the breadthways direction of the first blade when the excess of the application liquid on the application section is scraped off by the first blade, since small diameter sections having a smaller diameter than the application section are formed, then the application liquid does not accumulate at the respective end sections of the first blade in the breadthways direction. Moreover, the excess of the application liquid which has wet and spread in the breadthways direction of the first blade and has moved in the direction from the application section to the small diameter section flows down by passing over the second blade and therefore is never conveyed to the base material when the application cylinder is rotated.

By this means, even if the application liquid is applied at high speed, it is possible to prevent a portion of the treatment liquid which has been scraped off by the first blade from wetting and spreading in the breadthways direction of the first blade. Hence, it is possible to prevent the thicker application of the liquid in the respective end sections of the base material, and it is also possible to prevent the application liquid from flowing over onto the rear surface of the base material. The liquid application apparatus according to this aspect of the present invention is particularly valuable as an application apparatus in an inkjet recording apparatus for applying a treatment liquid (application liquid) which contains a surfactant and is liable to create foam onto an intermediate transfer body at high speed.

Moreover, in the above aspect of the present invention, since the first blade does not make contact with any components other than the application cylinder, in contrast to the related art technology (Japanese Patent Application Publication No. 5-220430), then a stable state of scraping off the excess of the application liquid is achieved. Moreover, since there are no cover members as used in the related art, then fixing mechanisms for same are not required, and furthermore, there is no deformation of the base material and therefore good contact is achieved between the base material and the application cylinder. By this means, it is possible to apply the application liquid to the base material in a uniform fashion.

Furthermore, since the contact positions of the first blade and the second blade are differentiated in such a manner that the first blade makes contact only with the application section and the second blade makes contact with the small diameter sections which have a smaller diameter than the application section, then a simple structure is obtained. Consequently, there are no requirements for high-precision processing, and the first and second blades can be assembled in a simple manner and their positions can be adjusted during assembly.

Moreover, since the adherence of unwanted application liquid to the application cylinder is suppressed by arranging the two small diameter sections on both ends of the application section, then there is no leaking of the application liquid to the exterior from the bearing sections which support the application cylinder in a rotatable fashion.

Preferably, the application section of the application cylinder includes a gravure roller having a circumferential surface on which a plurality of recess-shaped cells are arranged, the plurality of recess-shaped cells retaining the application liquid that is supplied at the lower portion of the application section.

When the application section of the application cylinder includes a gravure roller, beneficial effects can be achieved. For example, by providing the small diameter sections in a gravure roller, the amount of application liquid taken up at either end section of the application cylinder either becomes zero or is reduced in comparison with a gravure roller which is not provided with the small diameter sections, and therefore unwanted adherence of application liquid to the gravure roller is suppressed. By this means, it is possible to increase the amount of application liquid supplied to the liquid receiving pan as a countermeasure for application liquid which is liable to foaming, thus suppressing the occurrence of foaming in the application liquid. Hence, insufficient retention of application liquid in the cells of the gravure roller does not occur.

Preferably, the application section of the application cylinder has a width narrower than the band-shaped base material.

By making the width of application section of the application cylinder narrower than the width of the band-shaped base material, then it is possible further to prevent the application liquid from flowing over onto the rear surface of the base material.

Preferably, the two small diameter sections are arranged so as not to come into contact with the application liquid in a state where the application cylinder is not rotated.

By this means, it is possible to suppress unwanted adherence of application liquid to the application cylinder, and the unwanted conveyance of application liquid to the base material can be prevented. When the application cylinder is being rotated at high speed, then in the liquid receiving pan, the liquid surface rises up on the downstream side in terms of the direction of rotation of the round application cylinder, and therefore it is more preferable to set the relative positions of the liquid surface and the small diameter sections on the basis of the anticipated amount of the rise in the liquid surface.

Preferably, the second blade includes a supported section and a gravure roller contact section, the second blade bending at a bending position between the supported section and the gravure roller contact section, the gravure roller contact section of the second blade making contact with the two small diameter sections of the application cylinder, the second blade being arranged so that the bending position of the second blade is at a height not greater than that of an extended line of the contact line between the first blade and the circumferential surface of the application section.

In this aspect of the present invention, by using the second blade that bends at the bending position between the supported section and the gravure roller contact section, the surplus application liquid which has not been scraped off completely by the first blade and has wet and spread in the breadthways direction of the first blade flows down reliably by passing over the supported section or the gravure roller contact section of the second blade. By this means, it is possible to prevent thicker application of liquid at the respective end sections of the base material and overflow of liquid onto the rear surface of the base material, in an even more reliable fashion.

In this case, it is desirable that the surplus application liquid which has flowed down should be collected (recovered) in the liquid receiving pan or another recovery section, for example, an overflow receiving section which receives application liquid that has overflowed from the liquid receiving pan.

Preferably, the above-described liquid application apparatus further comprises a blade holding body which holds the first and second blades, wherein the first blade has a flexibility lower than the second blade.

In this aspect of the present invention, since the first blade is made less liable to bend than the second blade, then even if the first blade and the second blade are supported by the same blade holding body, the resistance to bending of the first blade is the dominant factor and hence there is no deterioration of the contact properties (adhesiveness) between the first blade and the circumferential surface of the application section. The relative magnitude of the flexibility can be determined based on the amount of bending of the blade when suspended between a pair of fulcrum members.

Preferably, the application section of the application cylinder has a side face that makes contact with an end of the second blade.

In this aspect of the present invention, even if the surplus application liquid which has not been scraped away completely by the first blade and which has wet and spread in the breadthways direction of the first blade flows onto the side face of the application section (the step difference face between the application section and the small diameter section), then it is possible to scrape off the liquid by means of the end of the second blade which is in contact with the side face of the application section. Moreover, even if the application liquid has adhered to the side face of the application section due to the high-speed revolution of the application cylinder, in a similar fashion, it is also possible to scrape off this liquid by means of end of the second blade on the side adjacent to the application section. Furthermore, if the application liquid has adhered to the small diameter section due to the high-speed revolution of the round application cylinder, this liquid is scraped off by the gravure roller contact section of the second blade.

Preferably, the above-described liquid application apparatus further comprises a third blade which is attached to the second blade so as to make contact with a side face of the application section of the application cylinder, the third blade being movable in an axle direction of the application cylinder.

In this aspect of the present invention, the blade abutment force by which the third blade abuts against the side face of the application section can be adjusted. In other words, by moving the third blade which is movably attached to the second blade in the axle direction of the gravure roller, it is possible to adjust the blade abutment force of the third blade abutting against the side face of the application section.

Preferably, the above-described liquid application apparatus further comprises a third blade which is detachably attached to the second blade so as to make contact with a side face of the application section of the application cylinder, the third blade having a flexibility different from that of the second blade.

In this aspect of the present invention, the blade abutment force of the third blade abutting against the side face of the application section can be adjusted. Since the third blade which is attached to the second blade can be detached and replaced so as to alter the flexibility of the third blade, then it is possible to adjust the blade abutment force of the third blade abutting against the side face of the application section.

Preferably, the first blade and the second blade are adjacently arranged to be parallel with each other.

In this aspect of the present invention, the first and second blades are arranged in parallel in the same direction rather than being arranged so as to oppose with each other, and therefore surplus application liquid which has not been scraped off completely by the first blade and which seeks to wet and spread in the breadthways direction of the first blade and move toward the side face of the application section and the small diameter section, flows down by passing over the second blade.

Supposing that the first blade and the second blade are arranged so as to oppose with each other, then after the surplus application liquid has flowed down onto the side face and the small diameter section of the application section, the liquid is scraped off when conveyed to the second blade via the position of the base material due to the rotation of the round application cylinder.

In order to attain the aforementioned object, the present invention is also directed to an inkjet recording apparatus which records an ink image on a recording medium, the inkjet recording apparatus comprising: a treatment liquid application device which includes the above-described liquid application apparatus, the treatment liquid application device applying treatment liquid that contains an aggregating agent onto an intermediate transfer body forming the band-shaped base material; an ink ejection device which deposits ink onto the intermediate transfer body on which the treatment liquid has been applied by the treatment liquid application device, the deposited ink being aggregated by the treatment liquid to form the ink image on the intermediate transfer body; and a transfer device which transfers the ink image on the intermediate transfer body to the recording medium.

In this aspect of the present invention, the above-described liquid application apparatus is used to apply treatment liquid onto the intermediate transfer body of an inkjet recording apparatus, and therefore even if the treatment liquid is applied at high speed in accordance with the high speed of the printing process, it is possible reliably to prevent a portion of the treatment liquid scraped off by the first blade from wetting and spreading in the breadthways direction of the first blade and causing thicker application of liquid at the respective end sections of the base material, or overflow of liquid onto the rear surface of the base material.

As described above, according to the above-described liquid application apparatus, even if the application liquid is applied at high speed, it is possible reliably to prevent a portion of the treatment liquid which has been scraped off by a blade from wetting and spreading in the breadthways direction of the blade, and thereby preventing the liquid from being applied more thickly in the respective end sections of the base material compared to the central region thereof, or preventing the liquid from flowing over onto the rear surface of the base material. Furthermore, the components provided in the liquid application apparatus for this purpose do not have any adverse effects on the accuracy of liquid application, or the like.

Consequently, by using the above-described liquid application apparatus in an inkjet recording apparatus to apply the treatment liquid onto a recording medium or an intermediate transfer body, it is possible to achieve an inkjet recording apparatus suitable for high-speed printing.

### BRIEF DESCRIPTION OF TEE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus according to a first embodiment of the present invention;

FIG. 2 is a principal plan diagram of the periphery of the print unit;

FIGS. 3A and 3B are plan view perspective diagrams showing the internal structure of a head;

FIG. 4 is a plan diagram showing a further example of the composition of a head;

FIG. 5 is a cross-sectional diagram along line 5-5 in FIGS. 3A and 3B;

FIG. 6 is a plan diagram showing an example of the arrangement of nozzles in a head;

FIG. 7 is an oblique diagram showing a first example of a liquid application apparatus used in a treatment liquid application unit;

FIG. 8 is a side view cross-sectional diagram of a liquid application apparatus;

FIGS. 9A and 9B are diagrams showing shapes of cells formed on the surface of the gravure roller;

FIG. 10 is an illustrative diagram describing the first and second blades of the liquid application apparatus;

FIG. 11 is a partial cross-sectional diagram describing the first and second blades of the liquid application apparatus;

FIG. 12 is a compositional diagram showing a second example of a liquid application apparatus used in a treatment liquid application unit;

FIG. 13 is a block diagram showing the system configuration of the inkjet recording apparatus according to a first embodiment;

FIG. 14 is a general schematic drawing of an inkjet recording apparatus according to a second embodiment of the present invention; and

FIG. 15 is a block diagram showing the system configuration of the inkjet recording apparatus according to a second embodiment.

### DETAILED DESCRIPTION OF THE PREFERRED EMBODIMENTS

Here, an inkjet recording apparatus forming the liquid application apparatus according to an embodiment of the present invention is described.

### General Composition of Inkjet Recording Apparatus

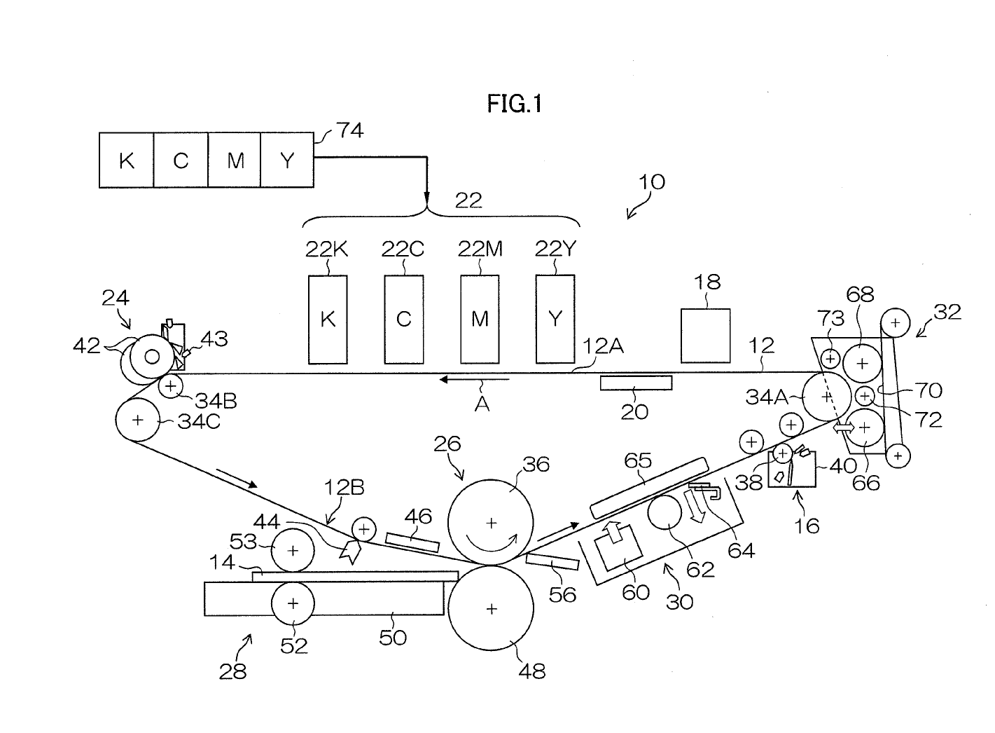

FIG. 1 is a diagram of the general composition of an inkjet recording apparatus according to a first embodiment of the present invention.

As shown in FIG. 1, the inkjet recording apparatus 10 according to the present embodiment is a recording apparatus which employs a transfer method in which an image (primary image) is recorded onto an intermediate transfer body 12 (base material) which is a non-permeable medium, and is then transferred to a recording medium 14 such as a normal paper, to form a main image (secondary image).

The inkjet recording apparatus 10 principally comprises a treatment liquid application unit 16 (corresponding to the “liquid application apparatus”) which applies an aggregating treatment liquid (hereinafter, simply called a “treatment liquid”) to an intermediate transfer body 12; a heating unit 18 and a cooler 20 for drying and cooling the treatment liquid which has been applied on the intermediate transfer body 12; a print unit (ink droplet ejection unit) 22 which deposits inks of a plurality of colors onto the intermediate transfer body 12; a solvent removal unit 24 which removes liquid solvent (excess solvent) on the intermediate transfer body 12 after deposition of ink droplets; a transfer unit 26 which transfers the ink image formed on the intermediate transfer body 12, onto a recording medium 14; a paper supply unit 28 which supplies a recording medium 14 to the transfer unit 26; and cleaning units (first cleaning unit 30 and a second cleaning unit 32) which cleans the intermediate transfer body 12 after transfer.

The treatment liquid is an acidic liquid which has the action of aggregating the coloring material which is contained in the ink, and the inks are colored inks which contain a coloring material (pigment) of the respective colors of cyan (C), magenta (M), yellow (Y) and black (K). The composition of the treatment liquid and the ink used in the present embodiment are described in detail hereinafter.

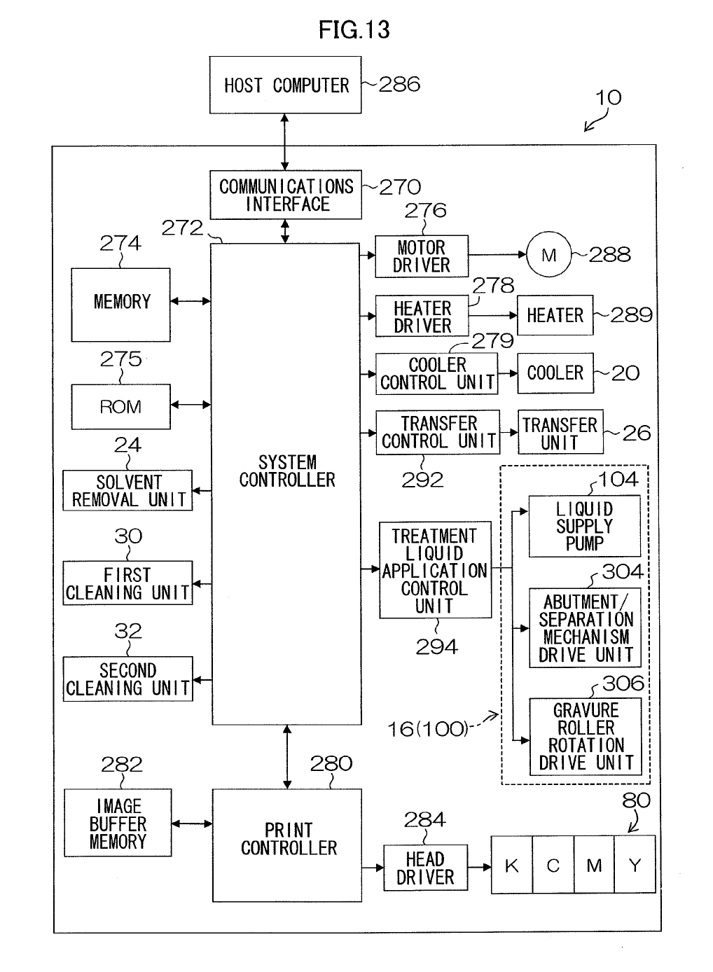

An endless belt is used for the intermediate transfer body 12. This intermediate transfer body (endless belt) 12 has a structure whereby it is wound about a plurality of rollers (three tensioning rollers 34A to 34C and a transfer roller 36 are depicted in FIG. 1, but the winding mode of the belt is not limited to this example), and the drive power of a motor (not shown in FIG. 1 and indicated by reference numeral 288 in FIG. 13) is transmitted to at least one of the tensioning rollers 34A to 34C or the transfer roller 36, thereby driving the intermediate transfer body 12 in a counter-clockwise direction in FIG. 1 (the direction indicated by the arrow A). The tensioning roller indicated by reference numeral 34C is a tensioner which serves to correct serpentine travel of the belt and to apply tension to the belt.

The intermediate transfer body 12 is formed of resin, metal, rubber, or the like, which has non-permeable properties that prevent permeation of liquid droplets of ink, in at least the image forming region (not shown) where the primary image is formed, of the surface (the image forming surface) 12A opposing the print unit 22. Furthermore, at least the image forming region of the intermediate transfer body 12 is composed so as to have a horizontal surface (flat surface) which has a prescribed flatness.

Desirable materials for use as the surface layer which includes the image forming surface 12A of the intermediate transfer body 12 are, for example, commonly known materials such as: a polyimide resin, a silicone resin, a polyurethane resin, a polyester resin, a polystyrene resin, a polyolefin resin, a polybutadiene resin, a polyamide resin, a polyvinyl chloride resin, a polyethylene resin, a fluorine resin, and the like.

The surface tension of the surface layer of the intermediate transfer body 12 is desirably set to be not less than 10 mN/m and not more than 40 mN/m. If the surface tension of the surface layer of the intermediate transfer body 12 is more than 40 mN/m, then the surface tension differential with respect to the recording medium 14 onto which the primary image is to be transferred disappears (or becomes extremely low), and the transfer properties of the ink aggregating body worsen. If, on the other hand, the surface tension of the surface layer of the intermediate transfer body 12 is less than 10 mN/m, then the design freedom (range of selection) of the intermediate transfer body 12 and the treatment liquid is restricted. This is because if the wetting properties of the treatment liquid are taken into account, it is necessary to set the surface tension of the treatment liquid to be lower than the surface tension of the surface layer on the intermediate transfer body 12, and it is difficult to make the surface tension of the treatment liquid not more than 10 mN/m,

From the viewpoint of the durability and transfer characteristics onto a normal paper, the intermediate transfer body 12 according to the present embodiment is desirably a body in which an elastic material having a surface energy approximately of 15 mN/m (=mJ/m²) through 30 mN/m, has been formed to a thickness of approximately 30 μm through 150 μm on the base material, such as polyimide, and it is preferable to provide a coating of silicone rubber, fluorine rubber, a fluorine elastomer, or the like as the elastic material.

The treatment liquid application unit 16 applies a treatment liquid (aggregating treatment agent) which forms an undercoating liquid onto the intermediate transfer body 12 after a cleaning step by a first cleaning unit 30, and the liquid application apparatus according to the present embodiment is arranged in this treatment liquid application unit 16. The treatment liquid application unit 16 according to the present embodiment applies treatment liquid to the image forming surface 12A of the intermediate transfer body 12 by rotating a gravure roller 38 (which corresponds to the round application cylinder) coated with treatment liquid in the opposite direction to the direction of conveyance of the intermediate transfer body 12 while making contact with the intermediate transfer body 12, and the detailed structure thereof is described later.

Furthermore, a desirable mode is one where the treatment liquid contains 1 to 5 wt % of polymer resin (micro-particles) with the object of enhancing the coloring material fixing properties and transfer characteristics when depositing droplets of ink. Moreover, it is desirable that the treatment liquid should include a fluorine-type surfactant at a ratio of several percent.

The heating unit 18 is arranged on the downstream side of the treatment liquid application unit 16 and on the upstream side of the print unit 22. The heating unit 18 according to the present embodiment uses a heater whose temperature can be adjusted in a range of 50° C. throuagh 100° C. The treatment liquid applied on the intermediate transfer body 12 by means of the treatment liquid application unit 16 is heated by passing through this heating unit 18 and the solvent component evaporates, thereby drying the liquid. Consequently, an aggregation treatment agent layer (namely, a thin film layer formed by drying the treatment liquid) which is in a solid state or a semi-solid state is formed on the surface of the intermediate transfer body 12.

The “aggregation treatment agent layer in a solid state or a semi-solid state” referred to here includes a layer of which the percentage of water content as defined below is 0% through 70%:

$$percentage of water content = \frac{A}{B} \times 100 ,$$

where A is weight of water contained in the treatment liquid after drying per unit surface area (g/m²), and B is weight of the treatment liquid after drying per unit surface area (g/m²).

A cooler 20 is arranged on the downstream side of the heating unit 18 in the conveyance direction of the intermediate transfer body, and on the upstream side of the print unit 22. This cooler 20 is arranged on the rear surface side of the intermediate transfer body 12. The cooler 20 can be controlled within a prescribed temperature range, and in the present embodiment; for example, it is controlled to 40° C. By cooling the intermediate transfer body 12 on which the aggregation treatment agent layer has been formed by heating and drying by the heating unit 18, to approximately 40° C. by means of the cooler 20, the radiated heat from the intermediate transfer body 12 is reduced, and the drying of the ink in the nozzles of the head in the print unit 22 is suppressed.

The print unit 22 disposed after the cooler 20 includes liquid ejection heads (hereinafter, referred to as “heads”) 22Y, 22M, 22C and 22K of an inkjet type which correspond to the respective ink colors of yellow (Y), magenta (M), cyan (C) and black (K).

The pigment-based inks of respective colors (C, M, Y, K) are ejected from the respective heads 22Y, 22M, 22C and 22K of the print unit 22 onto the aggregation treatment agent layer on the intermediate transfer body 12 which has passed through the cooler 20, in accordance with the image signal, thereby depositing droplets of the inks onto the aggregation treatment agent layer. In the case of the present embodiment, the ink ejection volume achieved by the respective heads 22Y, 22M, 22C and 22K is approximately 2 pl, and the recording density is 1200 dpi in both the main scanning direction (the breadthways direction of the intermediate transfer body 12) and the sub-scanning direction (the conveyance direction of the intermediate transfer body 12). The ink can also contain a polymer resin (micro-particles) having film forming properties, and in the case of this mode, the rub resistance and storage stability are improved in the transfer step and the fixing step.

When ink droplets are deposited onto the aggregation treatment agent layer, then the contact surface between the ink and the aggregation treatment agent layer has a prescribed surface area when the ink deposits, due to a balance between the propulsion energy and the surface energy. An aggregating reaction starts immediately after the ink has deposited on the aggregation treatment agent, and the aggregating reaction starts from the contact surface between the ink and the aggregation treatment agent layer. Since the aggregating reaction occurs only in the vicinity of the contact surface, and the coloring material in the ink aggregates while receiving an adhesive force in the prescribed contact surface area upon deposition of the ink, then movement of the coloring material is suppressed.

Even if another ink droplet is deposited adjacently to this ink droplet, since the coloring material of the previously deposited ink will already have aggregated, then the coloring material does not mix with the subsequently deposited ink, and therefore bleeding is suppressed. After aggregation of the coloring material, the separated ink solvent spreads, and a liquid layer containing dissolved aggregation treatment agent is formed on the intermediate transfer body 12.

As described above, an aggregate of the pigment is formed due to an aggregating reaction of the ink deposited onto the aggregation treatment agent layer, and his aggregate separates from the solvent. The solvent (residual solvent) component which has separated from the pigment aggregate is removed from the intermediate transfer body 12 by a solvent removal roller 42 of a solvent removal unit 24 which is arranged on the downstream side of the print unit 22.

The solvent removal roller 42 used here is desirably a roller which traps liquid in surface grooves (cells) by means of a similar principle to the gravure roller used for application. The liquid collected by the solvent removal roller 42 is removed from the solvent removal roller 42 by means of an air blower or liquid spraying action, or the like.

In this way, in a mode where solvent on the image forming surface 12A of the intermediate transfer body 12 is removed by means of a solvent removal roller 42, since the solvent on the intermediate transfer body 12 is removed appropriately, then there is no transfer of large quantities of solvent (dispersion medium) onto the recording medium 14 in the transfer unit 26. Hence, even in a case where a normal paper, or the like, is used as the recording medium 14, it is possible to prevent problems which are characteristic of water-based solvents, such as curling, cockling, or the like.

Moreover, by removing excess solvent from the ink aggregate by means of the solvent removal unit 24, the ink aggregate is condensed and the internal aggregating force is enhanced yet further. Consequently, adhesion of the resin particles contained in the ink aggregate is promoted effectively, and a stronger internal aggregating force can be applied to the ink aggregate, up until the transfer step carried out by the transfer unit 26. Moreover, by is achieving effective condensation of the ink aggregate by removal of the solvent, it is possible to apply good fixing properties and good luster to the image, even after transfer of the image to the recording medium 14.

It is not absolutely necessary to remove all of the solvent on the intermediate transfer body 12 by means of this solvent removal unit 24. If the ink aggregate is condensed excessively by removing an excessive amount of solvent, then the adhesion force of the ink aggregate on the transfer body becomes too strong, and therefore a very large pressure is needed for transfer, which is not desirable. Rather, in order to maintain a viscous elasticity which is suitable for transfer, it is desirable to leave a small amount of solvent.

Moreover, the following beneficial effects are obtained by leaving a small amount of solvent on the intermediate transfer body 12. Specifically, since the ink aggregate is hydrophobic, and the non-volatile solvent component (principally, the organic solvent, such as glycerine) is hydrophilic, then the ink aggregate and the residual solvent component separate after carrying out solvent removal, and a thin layer of liquid composed of the residual solvent component is formed between the ink aggregate and the intermediate transfer body. Consequently, the adhesive force of the ink aggregate on the intermediate transfer body 12 becomes weak, which is beneficial for improving transfer characteristics.

Since the volume of ink ejected as droplets onto the intermediate transfer body 12 varies in accordance with the image to be printed, then in the case of an image having a large white area (an image having a low ink volume), a mist spray is emitted from a mist spray nozzle 43 in order to supplement the low ink volume, in such a manner that the amount of water on the intermediate transfer body 12 is stabilized within a prescribed tolerable range;

A soiling determination sensor 44 for determining the soiling of the intermediate transfer body 12, and a pre-heater 46 forming a preliminary heating device are arranged on the downstream side of the solvent removal unit 24 and before the transfer unit 26, in terms of the conveyance direction of the intermediate transfer body. The pre-heater 46 according to the present embodiment is arranged on the rear surface 12B side of the intermediate transfer body 12, and hence the intermediate transfer body 12 on which the primary image has been formed is heated from the rear surface 12B side.

The heating temperature range of the pre-heater 46 is 90° C. through 130° C., and thus it is set to be not less than the heating temperature of the transfer unit 26 during transfer (in the present embodiment, 90° C.). Since the image formed on the intermediate transfer body 12 is transferred to the recording medium 14 in the transfer unit 26 after preliminarily heating the image forming region of the intermediate transfer body 12, then it is possible to set the heating temperature of the transfer unit 26 to a lower temperature than in a case where preliminary heating is not carried out, and furthermore, it is possible to shorten the transfer time of the transfer unit 26.

The transfer unit 26 is constituted of a transfer roller 36 including a heater (not shown in FIG. 1, and indicated by reference numeral 289 which represents a plurality of heaters, in FIG. 13), and a heating roller 48 performing a heating and pressurization nip, which is disposed opposing the transfer roller 36. In this way, a composition is achieved in which the intermediate transfer body 12 and the recording medium 14 are taken up in between the transfer roller 36 and the pressurization roller 48, and are pressurized at a prescribed pressure (nip pressure) while heating to a prescribed temperature, thereby transferring the primary image formed on the intermediate transfer body 12 to the recording medium 14.

The device for adjusting the nip pressure during transfer in the transfer unit 26 is, for example, a mechanism (drive device) which moves the transfer roller 36 or the pressurization roller 48, or both, in the vertical direction in FIG. 1.

A desirable nip pressure during transfer is 1.5 MPa through 2.0 MPa, and a desirable heating temperature (roller temperature) is 80° C. through 120° C. In the present embodiment, the transfer roller 36 and the pressurization roller 48 are both set to 90° C. If the heating temperature during transfer by the transfer roller is set too high, then there may be a problem of deformation of the intermediate transfer body 12, and the like, whereas if, on the other hand, the heating temperature is too low, then there may be a problem of poor transfer characteristics.

Furthermore, if the recording medium 14 is heated in advance (pre-heated) to a temperature of 70° C. through 100° C. in the paper supply unit 28 before transfer, then the transfer characteristics are further improved, which is desirable. In the case of the present embodiment, a heater 50 is provided in the paper supply unit 28 as a preliminary heating device for the recording medium 14. The recording medium 14 which has been preliminarily heated by the heater 50 is conveyed by the nip of the paper supply rollers formed by the pair of adhesive rollers 52 and 53, and is thereby supplied to the transfer unit 26.

The composition of the paper supply unit 28 may be based on a mode using a magazine for rolled paper (continuous paper), or a mode in which paper is supplied by means of a cassette in which cut paper is stacked and loaded, instead of or in combination with magazine for rolled paper. In the case of a configuration in which rolled paper is used, a cutter is provided and the rolled paper is cut to a desired size by the cutter. Alternatively, it is also possible to provide a plurality of magazines and cassettes having different paper widths, paper qualities, and the like.

In the case of a configuration in which a plurality of types of recording medium can be used, it is preferable that an information recording medium such as a bar code and a wireless tag containing information about the type of medium is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

Concrete examples of the recording medium 14 used in the present embodiment are: normal paper (including high-grade paper and recycled paper), permeable media, such as special inkjet paper, non-permeable media or low-permeability media, such as coated paper, sealed paper having adhesive or a detachable label on the rear surface thereof, a resin film, such as an OHP sheet, or a metal sheet, cloth, wood or other types of media.

The recording medium 14 supplied to the transfer unit 26 is heated and pressurized at a prescribed temperature and a prescribed nip pressure by means of the transfer roller 36 and the pressurization roller 48, and the primary image on the intermediate transfer body 12 is transferred onto the recording medium 14. The recording medium 14 (printed object) which has passed through the transfer unit 26 is separated from the intermediate transfer body 12 by means of a separating hook 56, and is output to the exterior of the apparatus by means of a conveyance device (not shown). Although not shown in FIG. 1, a sorter which accumulates the printed objects separately according to print orders, is provided in the printed object output unit.

The recording medium 14 (printed object) which has been separated from the intermediate transfer body 12 may undergo a fixing step (not shown) before being output from the apparatus. The fixing unit is, for example, constituted by a heating roller pair in which the temperature and pressing force can be adjusted. By adding a fixing step of this kind, the polymer micro-particles contained in the ink form a film (namely, a thin film is formed by the polymer micro-particles fusing on the outermost surface of the image), and therefore the rub resistance and storage properties are increased yet further. The heating temperature in the fixing step is desirably 100° C. through 130° C., the pressing force is desirably 2.5 MPa through 3.0 MPa, and these values are optimized in accordance with the temperature characteristics of the added polymer resin (e.g., the film forming temperature: MFT), and the like. Of course, since not only transfer characteristics but also film forming characteristics can be achieved in the transfer step in the transfer unit 26, then it is also possible to adopt a mode in which the fixing unit is omitted.

After the transfer step by the transfer unit 26, the intermediate transfer body 12 which has passed through the detachment unit formed by the separation hook 56 arrives at the first cleaning unit 30.

The first cleaning unit 30 is a device which cleans the intermediate transfer body 12 by using a cleaning liquid obtained by adding a surfactant, or the like, to water, such as distilled water or purified water, or solvent recovered by the solvent removal unit 24. The first cleaning unit 30 is constituted by a cleaning liquid spraying unit 60 which sprays the cleaning liquid, a rotating brush 62 which rotates in a reverse direction with respect to the direction of conveyance of the intermediate transfer body while making contact with the image forming surface 12A of the intermediate transfer body 12, and a blade 64 which slides and wipes the surface of the intermediate transfer body 12. Furthermore, the heater 65 is disposed on the rear surface side of the intermediate transfer body 12 in the first cleaning unit 30. The first cleaning unit 30 principally functions as a device which cleans the intermediate transfer body 12 after completing image transfer to the recording medium 14.

Although the liquid cleaning step performed by using the cleaning liquid in the first cleaning unit 30 is appropriate for high-speed continuous processing, a small amount of residual material is liable to remain on the intermediate transfer body 12, and there are limits on the stable cleaning which can be achieved in the edge portions of the intermediate transfer body 12. Consequently, due to the accumulation of residual material with operation over a long period of time, then problems may occur, such as deterioration in the transfer characteristics and sensitivity, soiling of the apparatus, operational defects, and the like.

Otherwise, if hard dust particles, such as grit particles, become attached to the intermediate transfer body due to the inflow of external air used for cooling the interior of the apparatus, the generation of dust inside the apparatus, or the performance of maintenance work or the like, then this dust may enter in between the wiping members (the rotating brush 62 and the blade 64) during liquid cleaning by the first cleaning unit 30, and it may give rise to damage, such as scratch marks on the intermediate transfer body 12.

From the viewpoint of solving these problems, in the present embodiment, a second cleaning unit 32 is provided which uses an adhesive member (adhesive rollers 66 and 68 for removing dust). The second cleaning unit 32 is constituted by adhesive rollers 66 and 68 which can be moved to control the contact state and the separation state with respect to the surface (12A) of the intermediate transfer body 12, and a cleaning web (or adhesive belt) 70 which is able to make contact with these adhesive rollers 66 and 68. As shown in FIG. 1, this second cleaning unit 32 is disposed at a position opposing the tensioning roller 34A. In FIG. 1, the reference numerals 72 and 73 are pressing rollers.

Either during non-image forming state such as standby state or before liquid cleaning during image formation, the adhesive rollers 66 and 68 are rotated while making contact with the intermediate transfer body 12, and therefore the foreign material on the intermediate transfer body 12 becomes attached to the adhesive rollers 66 and 68, thereby removing the foreign material (dust) from the intermediate transfer body and thus cleaning the surface of the intermediate transfer body.

The foreign material which has become attached to the surface of the adhesive rollers 66 and 68 can be transferred to the cleaning web (or the adhesive belt) 70, by separating the adhesive rollers 66 and 68 from the intermediate transfer body 12 and rotating the adhesive rollers 66 and 68 in contact with the cleaning web (or adhesive belt) 70. Consequently, it is possible to clean the surface of the adhesive rollers 66 and 68.

Furthermore, the composition of the principal part of the inkjet recording apparatus 10 will be described in more detail.

### Compositional Example of Print Unit

As shown in FIG. 1, the print unit 22 comprises heads 22Y, 22M, 22C, 22K corresponding to the respective colors, provided in the sequence of yellow (Y), magenta (M), cyan (C), black (K), from the upstream side following the conveyance direction of the intermediate transfer body.

The ink storing and loading unit 74 is constituted by an ink tank which stores respective ink liquids which are supplied respectively to the heads 22Y, 22M, 22C and 22K. The ink tanks are connected to the respectively corresponding heads, via prescribed flow channels, and hence the respectively corresponding ink liquids are supplied to the respective heads. The ink storing and loading unit 74 comprises a warning device (for example, a display device or an alarm sound generator) for warning when the remaining amount of any liquid in the tank is low, and has a mechanism for preventing loading errors between different colors.

The inks are supplied from the respective ink tanks of the ink storing and loading unit 74 to the respective heads 22Y, 22M, 22C and 22K, and droplets of the respectively corresponding colored inks are ejected respectively onto the image forming surface 12A of the intermediate transfer body 12, from the respective heads 22Y, 22M, 22C and 22K.

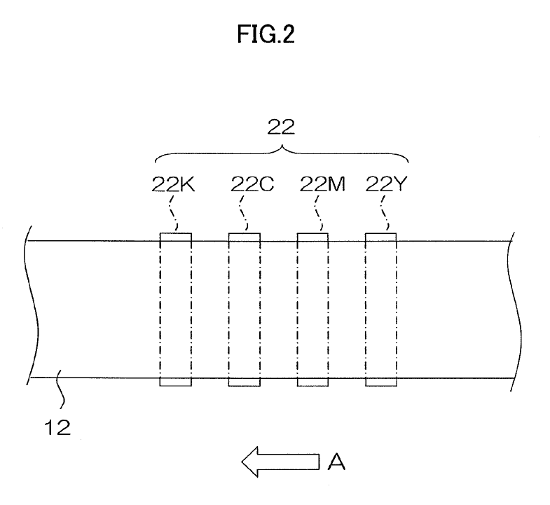

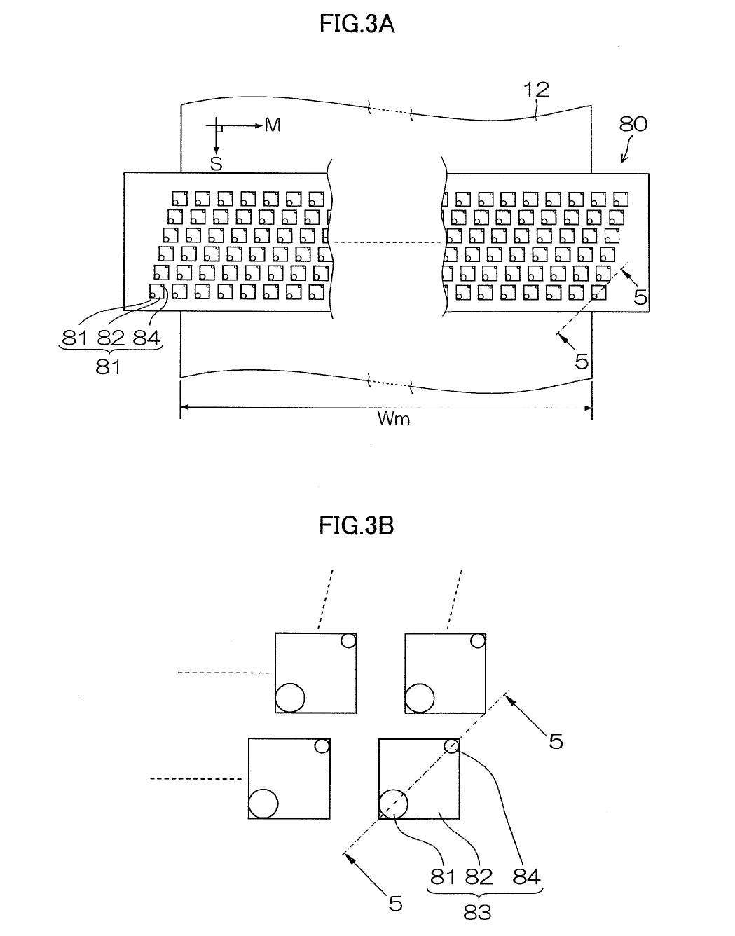

FIG. 2 is a diagram showing a plan diagram of the print unit 22. As shown in FIG. 2, the respective heads 22Y, 22M, 22C, 22K are each formed as full line type heads, which have a length corresponding to the maximum width of the image forming range of the intermediate transfer body 12, and comprises a nozzle row in which a plurality of nozzles for ejecting ink (not shown in FIG. 1, indicated by reference numeral 81 in FIGS. 3A and 3B) arranged through the full width of the image forming region, provided in the ink ejection surface of the head. The respective heads 22Y, 22M, 22C and 22K are disposed in a fixed position so as to extend in the direction perpendicular to the conveyance direction of the intermediate transfer body.

According to a composition where a full line head having a nozzle row covering the whole width of the intermediate transfer body 12 is provided for each type of ejection liquid, it is possible to form an image (primary image) on the image forming region of the intermediate transfer body 12, by performing just one operation of moving the intermediate transfer body 12 and the print unit 22 relatively in the conveyance direction of the intermediate transfer body 12 (the sub-scanning direction), (in other words, by means of one sub-scanning action). Therefore, it is possible to achieve a higher printing speed compared to a case which uses a serial (shuttle) type of head which moves back and forth reciprocally in the direction perpendicular to the conveyance direction of the intermediate transfer body (main scanning direction; see FIG. 2), and hence it is possible to improve the print productivity.

Although a configuration with the four standard colors of C, M, Y and K is described in the present embodiment, the combinations of the ink colors and the number of colors are not limited to those. Light and/or dark inks, and special color inks can be added as required. For example, a configuration is possible in which ink heads for ejecting light-colored inks, such as light cyan and light magenta, are added, and there is no particular restriction on the arrangement sequence of the heads of the respective colors.

### Structure of the Head

Next, the structure of respective heads will be described. The heads 22Y, 22M, 22C and 22K of the respective ink colors have the same structure, and a reference numeral 80 is hereinafter designated to any of the heads.

FIG. 3A is a plan view perspective diagram showing an example of the composition of a head 80, and FIG. 3B is an enlarged diagram of a portion of same. In order to achieve a high density of the dot pitch printed onto the surface of the recording medium 14, it is necessary to achieve a high density of the nozzle pitch in the head 80. As shown in FIGS. 3A and 3B, the head 80 according to the present embodiment has a structure in which a plurality of ink chamber units (liquid droplet ejection elements forming recording element units) 83, each including a nozzle 81 forming an ink ejection port, a pressure chamber 82 corresponding to the nozzle 81, and the like, are disposed (two-dimensionally) in the form of a staggered matrix, and hence the effective nozzle interval (the projected nozzle pitch) as projected in the lengthwise direction of the head (the direction perpendicular to the conveyance direction of the intermediate transfer body 12) is reduced (high nozzle density is achieved).

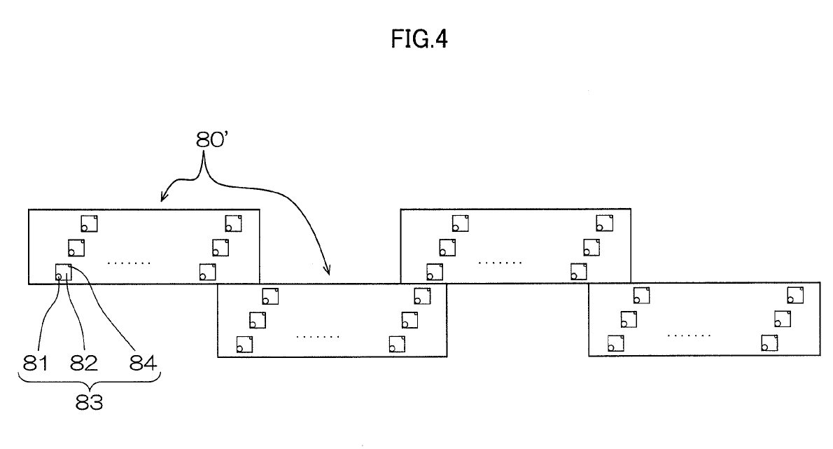

The mode of composing one or more nozzle rows through a length corresponding to the full width of the image forming region of the intermediate transfer body 12 in the direction, (in other words, in the direction indicated by arrow M in FIGS. 3A and 3B), substantially perpendicular to conveyance direction (arrow S in FIGS. 3A and 3B) of the intermediate transfer body 12, is not limited to the example shown in FIGS. 3A and 3B. For example, instead of the composition in FIG. 3A, as shown in FIG. 4, a line head having nozzle rows of a length corresponding to the entire width of the image forming region of the intermediate transfer body 12 can be formed by arranging and combining, in a staggered matrix, short head modules 80′ each having a plurality of nozzles 81 arrayed in a two-dimensional fashion.

As shown in FIGS. 3A and 3B, the planar shape of the pressure chamber 82 provided corresponding to each nozzle 81 is substantially a square shape, and an outlet port to the nozzle 81 is provided at one of the ends of a diagonal line of the planar shape, while an inlet port (supply port) 84 for supplying ink is provided at the other end thereof. The shape of the pressure chamber 82 is not limited to that of the present embodiment and various modes are possible in which the planar shape is a quadrilateral shape (diamond shape, rectangular shape, or the like), a pentagonal shape, a hexagonal shape, or other polygonal shape, or a circular shape, elliptical shape, or the like.

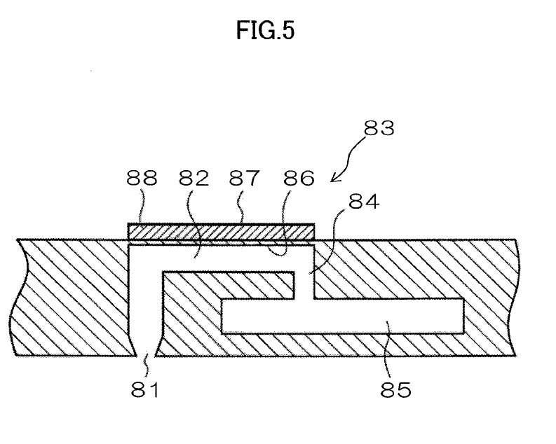

FIG. 5 is a cross-sectional diagram (along line 5-5 in FIG. 3A) showing the three-dimensional composition of the liquid droplet ejection element of one channel which forms a recording element unit in the head 80 (an ink chamber unit corresponding to one nozzle 81).

As shown in FIG. 5, each pressure chamber 82 is connected to a common flow passage 84 via the supply port 85. The common flow channel 85 is connected to an ink tank (not shown in FIG. 5, but equivalent to reference numeral 74 in FIG. 1), which is a base tank that supplies ink, and the ink supplied from the ink tank is supplied through the common flow channel 85 to the pressure chambers 82.

An actuator 88 provided with an individual electrode 87 is bonded onto a pressure plate (a diaphragm that also serves as a common electrode) 86 which forms the surface of one portion (in FIG. 5, the ceiling) of the pressure chambers 82. When a drive voltage is applied to the individual electrode 87 and the common electrode, the actuator 88 deforms, thereby changing the volume of the pressure chamber 82. This causes a pressure change which results in the ink being ejected from the nozzle 81. For the actuator 88, it is possible to adopt a piezoelectric element using a piezoelectric body, such as lead zirconate titanate, barium titanate, or the like. When the displacement of the actuator 88 returns to its original position after ejecting ink, the pressure chamber 85 is replenished with new ink from the common flow channel 84, via the supply port 82.

By controlling the driving of the actuators 88 corresponding to the nozzles 81 in accordance with the dot data generated from the input image by a digital half-toning process, it is possible to eject ink droplets from the nozzles 81. By controlling the ink ejection timing from the nozzles 81 in accordance with the speed of conveyance of the intermediate transfer body 12, while conveying the intermediate transfer body 12 in the sub-scanning direction at a uniform speed, it is possible to record a desired image (here, a primary image before transfer) onto the intermediate transfer body 12.

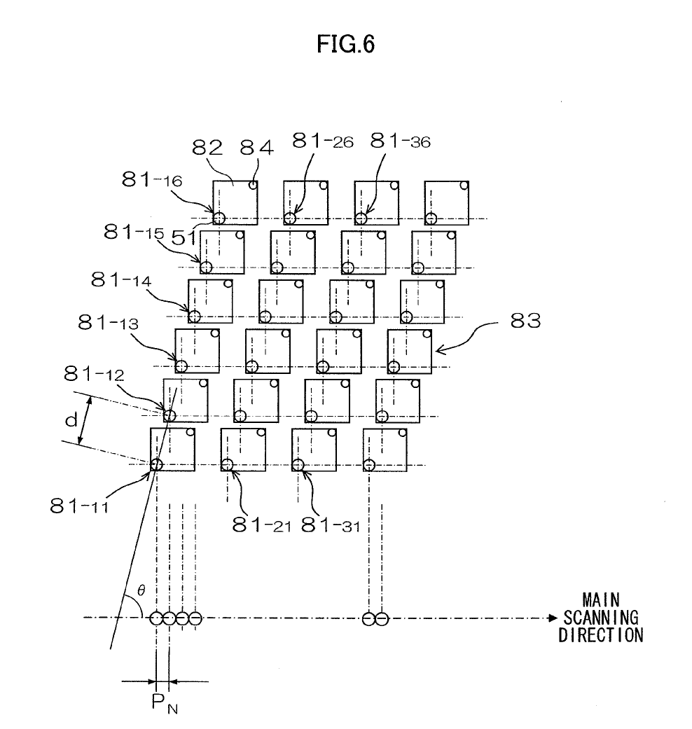

As shown in FIG. 6, the high-density nozzle head according to the present embodiment is achieved by arranging a plurality of ink chamber units 83 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 83 are arranged at a uniform pitch d in line with a direction forming an angle of θ with respect to the main scanning direction, the pitch P of the nozzles projected (normally) to an alignment in the main scanning direction is d×cos θ, and hence it is possible to treat the nozzles 81 as if they were arranged linearly at a uniform pitch of P. By adopting a composition of this kind, it is possible to achieve higher density of the effective nozzle rows when projected to an alignment in the main scanning direction.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the intermediate transfer body 12 (the direction perpendicular to the conveyance direction of the intermediate transfer body 12) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 81 arranged in a matrix such as that shown in FIG. 6 are driven, the main scanning according to the above-described (3) is preferred. More specifically, the nozzles 81-11, 81-12, 81-13, 81-14, 81-15 and 81-16 are treated as a block (additionally; the nozzles 81-21, . . . , 81-26 are treated as another block; the nozzles 81-31, . . . , 81-36 are treated as another block; . . . ); and one line is printed in the width direction of the intermediate transfer body 12 by sequentially driving the nozzles 81-11, 81-12, . . . , 81-16 in accordance with the conveyance velocity of the intermediate transfer body 12.

On the other hand, “sub-scanning” is defined as to repeatedly perform printing of one line (a line formed of a row of dots, or a line formed of a plurality of rows of dots) formed by the main scanning, while moving the full-line head and the intermediate transfer body 12 relatively to each other.

The direction indicated by one line (or the lengthwise direction of a band-shaped region) recorded by main scanning as described above is called the “main scanning direction”, and the direction in which sub-scanning is performed, is called the “sub-scanning direction”. In other words, in the present embodiment, the conveyance direction of the intermediate transfer body 12 is called the sub-scanning direction and the direction perpendicular to same is called the main scanning direction. In implementing the present invention, the arrangement of the nozzles is not limited to that of the example shown.

Moreover, a method is employed in the present embodiment where an ink droplet is ejected by means of the deformation of the actuator 88, which is typically a piezoelectric element; however, in implementing the present invention, the method used for discharging ink is not limited in particular, and instead of the piezo jet method, it is also possible to apply various types of methods, such as a thermal jet method where the ink is heated and bubbles are caused to form therein by means of a heat generating body such as a heater, ink droplets being ejected by means of the pressure applied by these bubbles.

### Preparation of Aggregation Treatment Agent

### TREATMENT LIQUID EXAMPLE 1

A treatment liquid (Example 1) is prepared according to the composition shown in Table 1. Thereupon, the physical properties of the treatment liquid (Example 1) thus obtained were measured, and the pH was 3.6, the surface tension was 28.0 mN/m, and the viscosity was 3.1 mPa·s.

TABLE 1

| Material | Weight % |
|---|---|
| 2-pyrrolidone-5-carboxylic acid (made by Tokyo Chemical | 10 |
| Industry Co., Ltd.) | |
| Lithium hydroxide-hydride (made by Wako Pure Chemical | 2 |
| Industries, Ltd.) | |
| Olfine E1010 (made by Nissin Chemical Industry Co., Ltd.) | 1 |
| Deionized water | 87 |

### TREATMENT LIQUID EXAMPLE 2

Moreover, a treatment liquid (Example 2) containing a surfactant is prepared according to the composition shown in Table 2. Thereupon, the physical properties of the treatment liquid (Example 2) thus obtained were measured, and the pH was 3.5, the surface tension was 18.0 mN/m, and the viscosity was 10.1 mPa·s.

TABLE 2

| Material | Weight % |
|---|---|
| 2-pyrrolidone-5-carboxylic acid (made by Tokyo Chemical | 10 |
| Industry Co., Ltd.) | |
| Lithium hydroxide-hydride (made by Wako Pure Chemical | 2 |
| Industries, Ltd.) | |
| Olfine E1010 (made by Nissin Chemical Industry Co., Ltd.) | 1 |
| Fluorine surfactant 1 | 3 |
| Deionized water | 84 |

The chemical formula of the fluorine surfactant 1 used in (Table 2) is as follows.

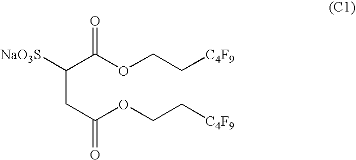

### Preparation of Ink

An example of the preparation of an ink used in the present embodiment is described below.

### <Preparation of (Polymer Dispersion) Cyan Ink>

A solution comprising 6 parts by weight of styrene, 11 parts by weight of stearyl methacrylate, 4 parts by weight of styrene macromer AS-6 (made by Toa Gosei Co., Ltd.), 5 parts by weight of “Premmer” PP-500 (made by NOF Corp.), 5 parts by weight of methacrylic acid, 0.05 parts by weight of 2-mercaptoethanol, and 24 parts by weight of methylethyl ketone was prepared in a reaction vessel.

On the other hand, a mixed solution was prepared by introducing, into a titration funnel, 14 parts by weight of styrene, 24 parts by weight of stearyl methacrylate, 9 parts by weight of styrene macromer AS-6 (made by Toa Gosei), 9 parts by weight of “Premmer” PP-500 (made by NOF Corp.), 10 parts by weight of methacrylic acid, 0.13 parts by weight of 2-mercapotoethanol, 56 parts by weight of methylethyl ketone, and 1.2 parts by weight of 2,2′-azobis (2,4-dimethyl valeronitrile).

Thereupon, the mixed solution inside the reaction vessel was raised to a temperature of 75° C. while being agitated, in a nitrogen atmosphere, and the mixed solution in the titration funnel was gradually added by titration over a period of one hour. When two hours had passed after the end of titration, a solution obtained by dissolving 1.2 parts by weight of 2,2′-azobis (2,4-dimethyl valeronitrile) in 12 parts by weight of methylethyl ketone was added by titration over a period of 3 hours, and the mixture was matured for a further two hours at 75° C. and two hours at 80° C., thereby yielding a polymer dispersant solution.

A portion of the polymer dispersant solution thus obtained was separated by removing the solvent, and the resulting solid component was diluted to 0.1 wt % with tetrahydrofuran, and then measured with a high-speed GPC (gel permeation chromatography) apparatus HLC-82220GPC, using three sequential columns: TSKgel Super HZM-H, TSKgel Super HZ4000, TSKgel Super HZ2000. The weight-average molecular weight was 25,000, when indicated as the weight of a polystyrene molecule.

5.0 g, by solid conversion, of the obtained polymer dispersant, 10.0 g of the cyan pigment, Pigment Blue 15:3 (made by Dainichiseika Color and Chemicals Mfg.), 40.0 g of methylethyl ketone, 8.0 g of 1 mol/L sodium hydroxide, 82.0 g of deionized water, and 300 g of 0.1 mm zirconia beads were supplied to a vessel, and dispersed for 6 hours at 1000 rpm in a “Ready Mill” dispersion machine (made by IMEX). The dispersion thus obtained was condensed at reduced pressure in an evaporator until the methyl ethyl ketone had been sufficiently removed, and the pigment density becomes 10%. The pigment particle size of the cyan dispersion liquid thus obtained was 77 nm.

Using this cyan dispersion, an ink was prepared to achieve the composition shown in Table 3, and the prepared ink was then passed through a 5 μm filter to remove coarse particles, thereby obtaining a cyan ink (C1-1). Thereupon, the physical properties of the cyan ink C1-1 thus obtained were measured, and the pH was 9.0, the surface tension was 32.9 mN/m, and the viscosity was 3.9 mPa·s.

TABLE 3

| Material | Weight % |
|---|---|
| Cyan pigment (Pigment Blue 15:3) made by Dainichiseika | 4 |
| Color and Chemicals Mfg Co., Ltd. | |
| Polymer dispersant | 2 |
| Latex LX-2 | 8 |
| Glycerine (made by Wako Pure Chemical Industries Co., Ltd.) | 20 |
| Diethylene glycol (made by Wako Pure Chemical | 10 |
| Industries Co., Ltd.) | |
| Olfine E1010 (made by Nissin Chemical Industry Co., Ltd.) | 1 |
| Deionized water | 65 |

Magenta, yellow and black inks were also prepared in a similar fashion to the above.

### Additional Polymer

Particles of a polymer resin, or the like, are added to the treatment liquid (aggregation treatment liquid) and ink described above, as appropriate. In the treatment liquid, it is desirable to introduce particles having a particle size of 1 μm through 5 μm and a melting point of 60° C. through 120° C., in order to stabilize the coloring material and improve transfer performance, whereas in the ink, it is desirable to introduce particles having a particle size of 1 μm or less and a glass transition point of 40° C. through 60° C., at a ratio of 1% through 5%, in order to fix the image. A compositional example is shown in Table 4.

TABLE 4

| | | Particle | Tg | MFT | Tm |
|---|---|---|---|---|---|
| Category | Composition | diameter [μm] | [° C.] | [° C.] | [° C.] |
| Aggregation | Low-molecular- | 4 | — | — | 110 |
| treatment | weight ethylene | | | | |
| agent (LX-1) | Low-molecular- | 1 | — | — | 110 |
| | weight ethylene | | | | |
| | Paraffin wax | 0.3 | — | — | 66 |
| Ink (LX-2) | Acrylic | 0.12 | 47 | 65 | — |
| | Styrene acrylic | 0.07 | 49 | 46 | — |

Tg: glass transition point;
Tm: melting point

### Composition of Treatment Liquid Application Unit

### <First Example of Liquid Application Apparatus>

The liquid application apparatus 100 according to an embodiment of the present invention can be used in an application method in which the treatment liquid which has been taken up from a liquid receiving pan by rotating the round application cylinder is adjusted to a prescribed application amount by a blade and is then applied to an intermediate transfer body 12 (base material). In the following description, the liquid application apparatus 100 is described in an example of a direct gravure coater method which uses a gravure roller as the round application cylinder.

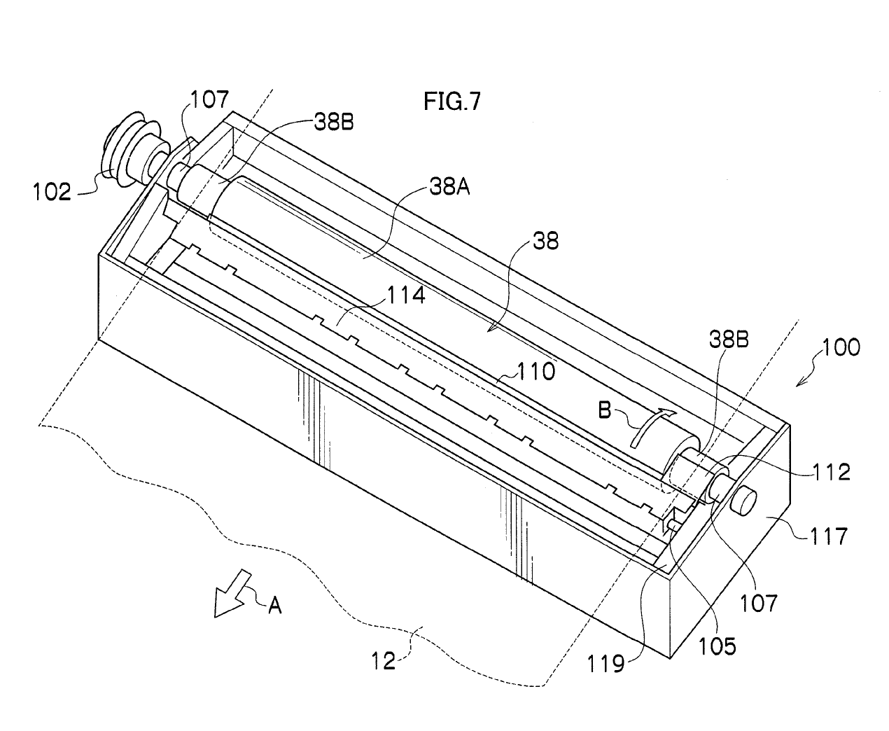

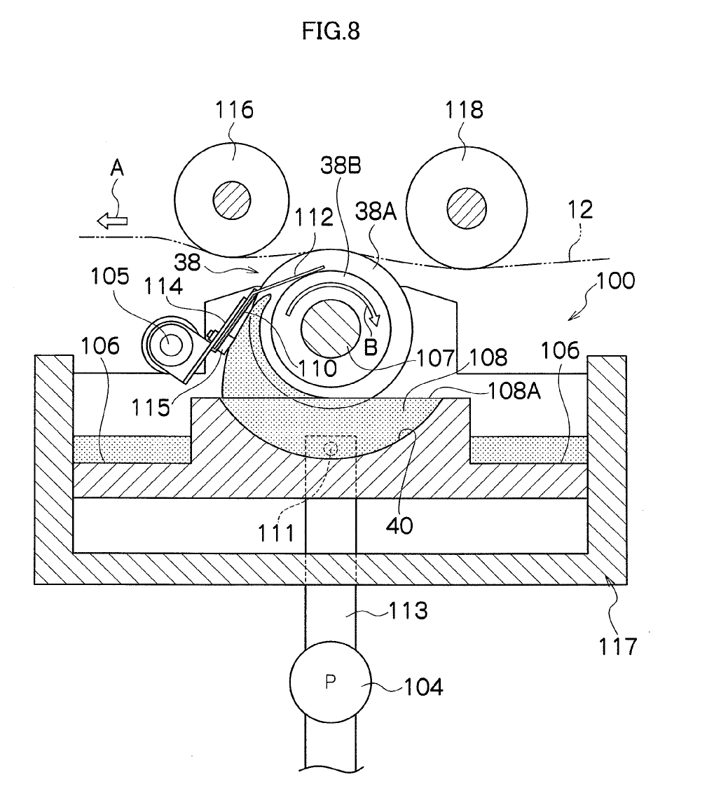

FIG. 7 is an overall perspective diagram of the liquid application apparatus 100 as viewed from an upper oblique direction, and FIG. 8 is a side cross-sectional diagram of FIG. 7.

In FIGS. 7 and 8, the intermediate transfer body 12 is conveyed in the direction of arrow A. As shown in these diagrams, in the liquid application apparatus 100, the upper portion of the circumferential surface of the application portion 38A of the gravure roller 38 makes contact with the band-shaped intermediate transfer body 12 which is conveyed in a continuous fashion, and the lower portion of the application section 38A is immersed in treatment liquid 108 inside the liquid receiving pan 40. As shown in FIG. 8, the treatment liquid 108 is supplied to the liquid receiving pan 40 from a supply port 111, via a treatment liquid channel 113, by means of a liquid supply pump 104. Overflow receiving sections 106 are provided on the upstream side and downstream side of the liquid receiving pan 40 (in terms of the direction of conveyance of the intermediate transfer body 12), and as for the treatment liquid which is supplied continuously from the supply port 111, the treatment liquid 108 flows over into the overflow receiving section 106 from the liquid receiving pan 40. Furthermore, the treatment liquid 108 which has overflowed into the overflow receiving sections 106 is recycled back to the liquid receiving pan 40 by means of a circulation system (pump, pipes, etc.) which are not illustrated. By this means, the liquid surface inside the liquid receiving pan 40 is kept to the overflow surface at all times, and the level of the treatment liquid 108 is kept uniform. Reference numeral 108A in FIG. 8 denotes the liquid surface when the gravure roller 38 is not being rotated.

The gravure roller 38 is driven to rotate at a uniform speed in the direction B in FIGS. 7 and 8 (the opposite direction to the direction A of conveyance of the intermediate transfer body 12) by means of the rotational driving force of a motor (not illustrated) being transmitted to the gravure roller 38 via a drive pulley 102. The treatment liquid 108 in the liquid receiving pan 40 is taken up and adheres to the circumferential surface of the gravure roller 38 by rotating the gravure roller in the direction B. The surplus amount of the treatment liquid 108 adhering to the circumferential surface of the gravure roller 38 is scraped off to achieve a prescribed application amount by the first blade 110. The treatment liquid 108 of the adjusted amount on the circumferential surface of the gravure roller 38 is transferred and applied onto the lower surface of the intermediate transfer body 12 by means of the gravure roller 38 making contact with the intermediate transfer body 12.

A desirable mode is one in which the rotational drive device of the gravure roller 38 (not illustrated) uses direct drive by an inverter motor (direct shaft coupling), but it is not limited to this mode, and it is also possible to use a combination of various types of motor and a reduction gear device, or a combination of various types of motor and a wound transmission device, such as a timing belt.

Moreover, the gravure roller 38 is supported movably in the vertical direction by means of a movement mechanism (abutment/separation mechanism), which is not illustrated, and therefore it can be controlled and switched between a state where the gravure roller 38 is pressed against the intermediate transfer body 12, and a state where it has been separated (retracted) from the intermediate transfer body 12.

The gravure roller 38 is constituted of an application section 38A which makes contact with the first blade 110, and small diameter sections 38B which are formed at either side of the application section 38A. The diameter of the small diameter sections 38B is set to be smaller than the diameter of the application section 38A. A rotating shaft 107 of the gravure roller 38 is arranged on an end (i.e., the end where the application section 38A is not arranged) of each of the small diameter sections 38B, and the diameter of the rotating shaft 107 is formed to be smaller than the diameter of the small diameter sections 38B. Desirably, the diameter “D” of the application section 38A is not greater than 40 mm, and more desirably not greater than 30 mm, in order to form a thin film of the treatment liquid 108 and to compactify the apparatus. In other words, it is desirable that the application section 38A should have a small diameter compared to a general gravure roller (having a diameter of approximately 50 mm through 80 mm) which is used in a general gravure printing apparatus or gravure application apparatus, etc. In this case, the lower limit of the diameter D of the application section 38A is desirably set to approximately 30 mm in order to prevent warping of the gravure roller 38. If the diameter D of the application section 38A is set to the range described above, then desirably the amount of immersion by which the lower end portion of the application section 38A is immersed in the treatment liquid 108 stored in the liquid receiving pan 40 is set to a range of 1 to 4 mm, and more desirably, a range of 2 to 3 mm.

Furthermore, the small diameter sections 38B of the gravure roller 38 do not contribute to the application of the treatment liquid 108, and the small diameter sections 38B are arranged so as not to be immersed in the treatment liquid 108 in the liquid receiving pan 40 when the gravure roller 38 is not being rotated. Consequently, as stated above, it is desirable that the diameter D of the small diameter sections 38B should be smaller than that of the application section 38A, and more specifically, the small diameter sections 38B preferably have a diameter of 16 mm through 22 mm.

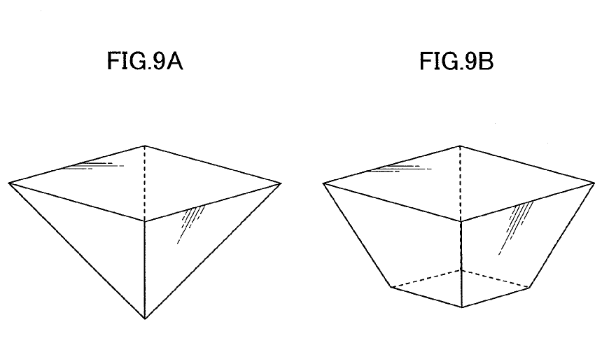

A plurality of very fine cells (see FIGS. 9A and 9B) which are engraved in a pyramid shape or a lattice shape (truncated pyramid shape) are formed at a prescribed density in the surface of the application section 38A of the gravure roller 38. There are no particular restrictions of the mode of arrangement of the cells on the surface of the application section 38A of the gravure roller 38, and a desirable mode is one in which the cells are aligned in an oblique direction which is not perpendicular to the direction of rotation. The shape, depth, volume and density of the cells are determined appropriately in accordance with the amount of liquid which is to be applied (the thickness of the liquid film after application).

Furthermore, as shown in FIG. 8, the pressing rollers 116 and 118 are arranged on the opposite side of the gravure roller 38 (the upper side in FIG. 8) via the intermediate transfer body 12. The pressing rollers are arranged on the upstream side and the downstream side of the gravure roller 38, respectively. The two pressing rollers 116 and 118 are arranged in parallel alignment at a prescribed interval apart in the conveyance direction of the intermediate transfer body 12, and the gravure roller 38 is arranged approximately at the midpoint between the two pressing rollers 116 and 118 in the direction of conveyance of the intermediate transfer body 12. The pressing rollers 116 and 118 are omitted from the image shown in FIG. 7.

As shown in FIG. 8, during application, the gravure roller 38 is pressed against the intermediate transfer body 12, and the intermediate transfer body 12 is pressed up between the pressing rollers 116 and 118. The intermediate transfer body 12 which is interposed (nipped) between the gravure roller 38 and the pressing rollers 116 and 118 is bent so as to follow the upper circumferential surface of the gravure roller 38, and hence the adhesion with respect to the gravure roller 38 is raised and the contact surface area can also be guaranteed. By controlling the amount by which the gravure roller 38 is pressed against the intermediate transfer body 12, it is possible to adjust the angle of bending (angle of lap) of the intermediate transfer body 12 with respect to the gravure roller 38.

By conveying the intermediate transfer body 12 at a uniform speed in this nipped state and causing the gravure roller 38 to rotate in reverse with respect to the direction of conveyance of the intermediate transfer body, a thin film having a uniform film thickness can be applied to the image forming surface 12A of the intermediate transfer body 12 which forms a liquid application receiving member. In this case, the pressing rollers 116 and 118 rotate in a direction of rotation which follows the direction of conveyance, in accordance with the conveyance of the intermediate transfer body 12.

In the liquid application apparatus 100 according to the present embodiment, it is desirable that the density of the cells of the gravure roller 38 should be 100 through 250 lines/inch (and desirably, 150 through 200 lines/inch), and that the depth should be in the range of 45 μm through 70 μm. By this means, it is possible to apply a thin film having low visibility of the application pattern, and a uniform application thickness of 1 μm through 25 μm. Moreover, when the density of the cells is set to 150 through 165 lines/inch, then it is possible to form a uniform liquid film having a thickness of approximately 1 μm through 10 μm (more desirably, 1 μm to 5 μm and especially desirably, 1 μm to 3 μm), and hence there is no flow of liquid on the intermediate transfer body, which is even more desirable since it produces good fixing properties when ink droplets are deposited.

It is necessary to accelerate the speed of application of the treatment liquid 108 by the liquid application apparatus 100 in response to the high-speed printing performed by the inkjet recording apparatus 10, and desirably, the conveyance speed of the intermediate transfer body 12 is in the range of 500 through 660 mm/sec (30 through 40 m/min). Furthermore, in order to ensure stable application during high-speed application, desirably the rotational circumferential speed of the gravure roller 38 is made greater than the speed of conveyance of the intermediate transfer body 12, and preferably it is set to the range of 1.2 to 1.6 times in terms of the relative speed ratio. For example, when the conveyance speed of the intermediate transfer body 12 is set to 500 mm/sec, then it is desirable that the rotational circumferential speed of the gravure roller 38 should be set to the range of 600 to 830 mm/sec (36 to 50 m/min). In this case, if the diameter of the application section 38A is 30 mm, then the number of revolutions of the gravure roller 38 will be 380 to 530 rpm.

Furthermore, desirably, the relationship between the width of the intermediate transfer body 12 and the width of the application section 38A is such that the width of the intermediate transfer body 12 is greater than that of the application section 38A. By this means, it is possible to prevent the treatment liquid 108 from flowing over onto the rear surface of the intermediate transfer body 12 (the upper surface of the intermediate transfer body 12 in FIG. 8) when the treatment liquid 108 which has been applied onto the intermediate transfer body 12 wets and spreads in the breadthways direction of the intermediate transfer body.

Next, the first blade 110 and the second blade 112 will be described.

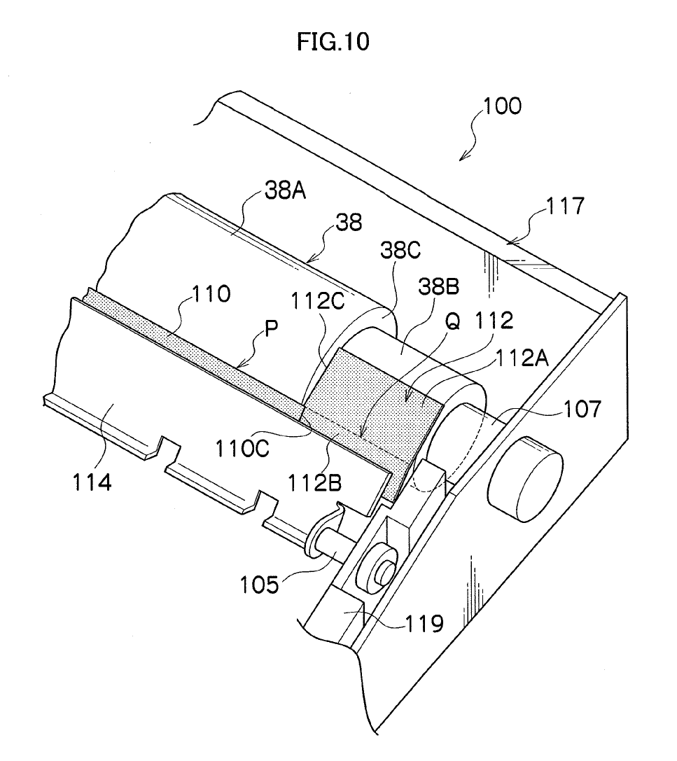

As shown in FIGS. 8, 10 and 11, the first blade 110 is formed in the shape of a thin plate, and is held on a blade bracket 114. The blade bracket 114 is supported revolvably on a bracket supporting axle 105 which is supported by an axle supporting section 119 of the apparatus main body 117. Furthermore, a pressing mechanism (for example, a pressing screw) which is not shown is provided in either end portion of the blade bracket 114, thereby impelling the blade bracket 114 toward the gravure roller 38. Thereby, the front tip of the first blade 110 is made to contact with the application section 38A of the gravure roller 38 at a prescribed pressing force. The line on which the front tip of the first blade 110 makes contact with the circumferential surface of the application section 38A is referred to as a “contact line P” (see FIG. 10).

Desirably, the width of the first blade 110 and the width of the application section 38A of the gravure roller 38 are substantially the same, but taking account of the assembly of the unit in the breadthways direction of the gravure roller 38, it is desirable that the width of the first blade 110 should be longer than the width of the application section 38A by approximately 1 mm or less.

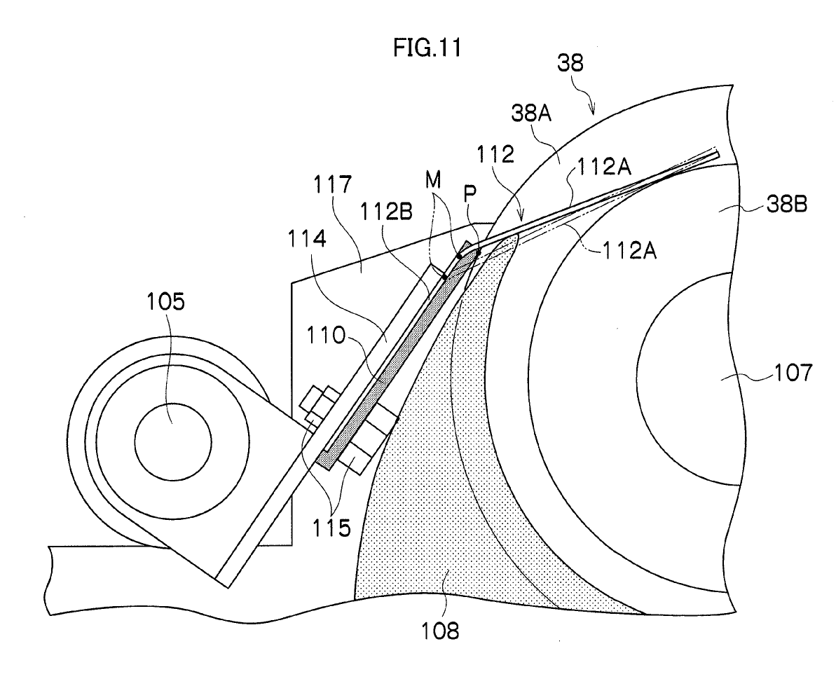

Since the first blade 110 is formed in the shape of a thin plate as described above, and the front tip thereof is pressed against the application section 38A of the gravure roller 38, then the front tip of the blade suffers wear during its use. Hence, it is desirable that the first blade 110 should be held detachably on the blade bracket 114 by means of a fastening device 115 such as a nut and bolt, or the like, (see FIG. 11). The thickness of the first blade 110 is desirably in the range of 0.5 to 3.0 mm, and more desirably, in the range of 0.5 to 2.0 mm. The reason for this is that this range satisfies both the scraping properties of the treatment liquid 108 by the first blade 110 and the strength of the first blade 110. The material of the first blade 110 is desirably a metal material such as stainless steel, aluminum alloy, or the like, from the viewpoint of strength, but it is also possible to use a resin material or a ceramic material.

The second blade 112 is also supported by the blade bracket 114, similarly to the first blade 110. In other words, as FIG. 10 reveals, the blade bracket 114 is formed to have a greater width than the application section 38A of the gravure roller 38, and a supported section (base portion) 112B of the second blade 112 is supported by either end portion of the blade bracket 114. In this case, the width of the first blade 110 is slightly greater than that of the application section 38A (approximately 0 to 2 mm longer), and the side end 110C of the first blade 110 and the end 112C of the second blade 112 are desirably formed so as to be slightly overlapping as shown in FIG. 10. Accordingly, the surplus treatment liquid which has been scraped away by the first blade 110 and has wet and spread in the breadthways direction of the blade is liable to flow down readily by passing along the second blade 112. However, it is desirable that the overlapping sections do not make contact with each other.

With respect to the state of contact between the second blade 112 and the circumferential surface of the small diameter section 38B, it is not necessary for the front tip (edge) of the blade to make contact with this circumferential surface as in the first blade 110, and the circumferential surface of the small diameter section 38B may come into contact with the lower surface of a gravure roller contact section (front tip section) 112A of the second blade 112.

Similarly to the first blade 110, the material of the second blade 112 is desirably a metal material such as stainless steel, aluminum alloy, or the like, from the viewpoint of strength, but it is also possible to use a resin material or a ceramic material. The flexibility of the first blade 110 is desirably less than the flexibility of the second blade 112. If the first blade 110 is made less liable to bend than the second blade 112 in this way, then even if the first blade 110 and the second blade 112 are supported on the same blade bracket 114, the resistance to bending of the first blade 110 has a dominant effect and hence there is no deterioration of the contact properties (adhesiveness) between the front tip of the first blade 110 and the circumferential surface of the application section 38A. In other words, there is no adverse effect on the state of contact in which the front tip of the first blade 110 is pressed in contact with the circumferential surface of the application section 38A, and therefore it is possible to improve the scraping properties when scraping away the surplus amount of the treatment liquid 108 which is adhering to the application section 38A. In the present embodiment, the first blade 110 and the second blade 112 are held by one blade bracket 114, but they may also be held by separate brackets. In this case, it is not necessary to pay particular attention to the flexibility of the first and second blades 110 and 112. Although not shown in the drawings, the relationship of the flexibility may be evaluated by the relative amount of bending of the blade plates when suspended between a pair of fulcrum members.

It is possible to alter the material or thickness between the first and second blades to make the flexibility of the first blade 110 smaller than the flexibility of the second blade 112, for example. When the material of both the first and second blades 110 and 112 is stainless steel, then if the thickness of the first blade 110 is set in the range of 0.5 to 3.0 mm as described above, the thickness of the second blade 112 is desirably set to a value less than 0.5 mm, and it may be set to 0.2 mm, for example.

As shown in FIG. 11, the second blade 112 is constituted of a supported section 112B, and a gravure roller contact section 112A which curves toward the small diameter section 38B of the gravure roller 38 from the supported section 112B and which makes contact with the circumferential surface of the small diameter section 38B. In other words, the second blade 112 has a shape in which it bends at a bending position M between the supported section 112B and the gravure roller contact section 112A. Moreover, desirably the bending position M is arranged at the same position or to the lower side of the an extended line Q (see FIG. 10) of the contact line P where the front tip of the first blade 110 makes contact with the circumferential surface of the application section 38A. In FIG. 11, the second blade 112 which is depicted by the double-dotted line shows a case where the second blade 112 is arranged below the extension line Q.

Furthermore, an end 112C of the second blade 112 on the side adjacent to the application section 38A is desirably in contact with the side face of the application section 38A (the surface of the step difference between the application section 38A and the small diameter section 38B), as shown in FIG. 10.

By using the gravure roller 38 constituted of the application section 38A and the small diameter sections 38B and arranging the first blade 110 and the second blade 112 as described above, then when scraping off the surplus treatment liquid on the application section 38A by means of the first blade 110, it is possible reliably to prevent liquid from being applied more thickly in the respective end portions of the intermediate transfer body 12 due to surplus treatment liquid which has not been completely scraped away by the first blade 110 and which has wet and spread in the breadthways direction of the first blade 110, and it is also possible to prevent the liquid from flowing over onto the rear surface of the intermediate transfer body 12.

In other words, when scraping away surplus treatment liquid of the application section 38A by means of a first blade 110, even if the liquid wets and spreads in the breadthways direction of the blade rather than being scraped away completely by the first blade 110, since the small diameter sections 38B having a smaller diameter than the application section 38A are formed, then the liquid never becomes excessive (accumulate) at the respective end sections in the breadthways direction of the first blade 110. Furthermore, the surplus treatment liquid which wets and spreads in the breadthways direction of the first blade 110 and moves in the direction from the application section 38A to the small diameter sections 38B flows down by passing over the supported section 112B of the second blade 112 and the gravure roller contact section 112A of the second blade 112.

In particular, when the gravure roller 38 is rotated quickly in order to perform high-speed application, the amount of treatment liquid 108 which is taken up from the liquid receiving pan 40 increases and the amount scraped off by the first blade 110 also increases. Therefore, the amount of surplus treatment liquid which wets and spreads on the first blade 110 increases as well. However, by composing the liquid application apparatus 100 as described above, the surplus treatment liquid which has wet and spread never adheres to the intermediate transfer body even when the gravure roller 38 rotates.

Supposing that a portion of the surplus treatment liquid that has wet and spread does not flow down over the second blade 112 but rather flows onto the side face 38C of the application section 38A, then since the liquid is scraped away by the end 112C of the second blade 112, the surplus treatment liquid never adheres to the intermediate transfer body during rotation of the gravure roller 38.

Consequently, even if the treatment liquid 108 is applied at high speed to the intermediate transfer body 12, it is possible reliably to prevent a portion of the treatment liquid 108 scraped off by the first blade 110 from wetting and spreading in the breadthways direction of the blade, thereby preventing the liquid from being applied more thickly in the respective end sections of the intermediate transfer body 12 or preventing the liquid from flowing over onto the rear surface of the intermediate transfer body 12.

Furthermore, even if the small diameter section 38B is arranged so as not to make contact with the treatment liquid 108 in the liquid receiving pan 40 when application is not being performed, treatment liquid 108 is liable to adhere readily to the side face 38C of the small diameter section 38B and the application section 38A due to the rise in the liquid surface of the liquid receiving pan 40 caused by the high-speed rotation of the gravure roller 38 during the high-speed application process. In other words, if the gravure roller 38 is rotated at high-speed in the rotational speed range described above, then the liquid surface in the liquid receiving pan 40 rises up on the side of the direction of rotation of the gravure roller 38 (the downstream side in terms of the direction of conveyance of the intermediate transfer body), and therefore the liquid surface on the side opposite to the direction of rotation (the upstream side) descends slightly. In particular, when the treatment liquid 108 contains a surfactant at a percentage of several %, then the rise in the liquid surface is especially notable and the treatment liquid 108 inside the liquid receiving pan 40 foams.

Even in cases of this kind, the treatment liquid 108 which has adhered to the small diameter section 38B is scraped off by the gravure roller contact section 112A of the second blade 112, and the treatment liquid 108 adhering to the side face 38C of the application section 38A is scraped away by the end 112C of the second blade 112.

Consequently, by composing the liquid application apparatus 100 as described above, it is possible reliably to prevent the liquid from being applied more thickly in the respective end sections of the intermediate transfer body 12 compared to the central region, and to prevent overflow of liquid onto the rear surface of the intermediate transfer body 12.

Moreover, the provided components do not have any adverse effects on the accuracy of application, and the like, as in the case of the related art. More specifically, since the first blade 110 does not make contact with any components other than the application section 38A, in contrast to the related art technology (Japanese Patent Application Publication No. 5-220430), then a stable state of scraping of the surplus application liquid is achieved. Moreover, since there are no cover members disclosed in the related art, then fixing mechanisms for same are not required, and furthermore, there is no deformation of the intermediate transfer body 12 and therefore good contact state is achieved between the intermediate transfer body 12 and the circumferential surface of the application section 38A. By this means, it is possible to apply the treatment liquid 108 onto the intermediate transfer body 12 in a uniform fashion.

Furthermore, since the contact position of the first blade 110 is different from that of the second blade 112 in such a manner that the first blade 110 only makes contact with the application section 38A and the second blade 112 makes contact with the small diameter section 38B which has a smaller diameter than the application section 38A, then a simple structure is achieved. Consequently, it is not necessary to form the first and second blades at high precision, and the first and second blades can be assembled in a simple manner and their positions can be adjusted during assembly.

Furthermore, since small diameter sections 38B are provided in the gravure roller 38 and adherence of unwanted treatment liquid 108 to the gravure roller 38 is suppressed, then there is no leaking of treatment liquid to the exterior from the axle bearing sections (not illustrated) which support the gravure roller 38 rotatably.

### Second Example of Liquid Application Apparatus

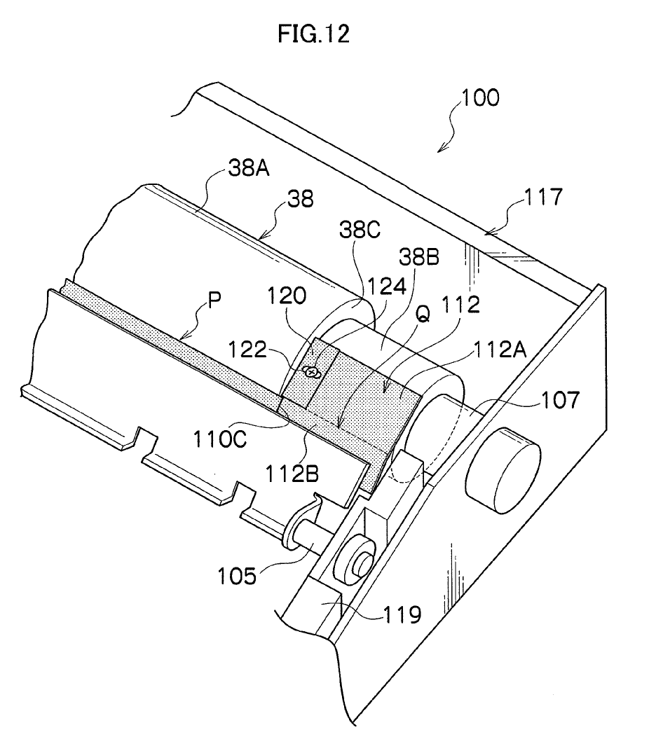

FIG. 12 is a diagram showing a second example of a liquid application apparatus 100. FIG. 12 shows a composition which has been improved in such a manner that the abutting force of the blade which abuts against the side face 38C of the application section 38A of the gravure roller 38 can be adjusted. As one composition for adjusting the abutting force, a third blade 120 which is moveable in the axial direction of the gravure roller 38 is attached to the second blade 112, and this third blade 120 is arranged so as to abut against the side face 38C of the application section 38A. By this means, it is possible to adjust the abutting force of the blade against the side face 38C of the application section 38A of the gravure roller 38.

One method for providing the third blade 120 in a movable fashion with respect to the second blade 112 is, for example, to form an elongated hole 122 which is elongated in the axel direction of the gravure roller 38, in the third blade 120, and to fix the third blade 120 onto the second blade 112 via a screw 124 passing through this elongated hole 122. However, the method is not limited to this and it is also possible to adopt any other method, provided that it enables the third blade 120 to be supported movably in the axial direction of the gravure roller 38 with respect to the second blade 112. In this case, desirably, the distance by which the third blade 120 is moved with respect to the second blade 112 is within 0.5 mm, for example, a very fine movement range of approximately 0.1 mm.

Moreover, as a further composition for adjusting the abutting force, it is also possible to compose the third blade 120 so as to have a variable flexibility. In this case, it is preferable that the flexibility of the third blade 120 should be greater (more bendable) than the flexibility of the second blade 112. Consequently, it is desirable that the first blade 110, the second blade 112 and the third blade 120 are set so as to be of successively increasing flexibility, in other words, so as to be successively more liable to bending, in this order.

It is possible to use a bendable film as the third blade 120, for example, and to prepare a plurality of bendable films having different levels of flexibility, the third blade 120 being detachably attached to the second blade 112 by means of a screw, or the like. As described above, the relative level of flexibility should be evaluated on the basis of the relative amount of bending of the bendable film when suspended between a pair of fulcrum members.

For the bendable film, it is desirable to use a PET (polyethylene terephthalate) film or PI (polyimide) film having a thickness of approximately 0.02 mm through 1.5 mm.

### Description of Control System

FIG. 13 is a principal block diagram showing the system configuration of the inkjet recording apparatus 10. The inkjet recording apparatus 10 comprises a communication interface 270, a system controller 272, a memory 274, a motor driver 276, a heater driver 278, a cooler control unit 279, a print controller 280, an image buffer memory 282, an ink head driver 284, and the like.

The communication interface 270 is an interface unit for receiving image data sent from a host computer 286. A serial interface such as USB (Universal Serial Bus), IEEE1394, Ethernet (registered trademark), wireless network, or a parallel interface such as a Centronics interface may be used as the communication interface 270. A buffer memory (not shown) may be mounted in this portion in order to increase the communication speed. The image data sent from the host computer 286 is received by the inkjet recording apparatus 10 through the communication interface 270, and is temporarily stored in the memory 274.

The image memory 274 is a storage device for temporarily storing images inputted through the communication interface 270, and data is written and read to and from the memory 274 through the system controller 272. The memory 274 is not limited to a memory composed of semiconductor elements, and a hard disk drive or another magnetic medium may be used.

The system controller 272 is constituted by a central processing unit (CPU) and peripheral circuits thereof, and the like, and it functions as a control device for controlling the whole of the inkjet recording apparatus 10 in accordance with a prescribed program, as well as a calculation device for performing various calculations. More specifically, the system controller 272 controls the various sections, such as the communication interface 270, memory 274, motor driver 276, heater driver 278, cooler control unit 279, and the like, as well as controlling communications with the host computer 286 and writing and reading to and from the memory 274, and it also generates control signals for controlling the motor 288 and heater 289 of the conveyance system.

The program executed by the CPU of the system controller 272 and the various types of data which are required for control procedures are stored in the ROM 275. The ROM 275 may be a non-writeable storage device, or it may be a rewriteable storage device, such as an EEPROM. The memory 274 is used as a temporary storage region for the image data, and it is also used as a program development region and a calculation work region for the CPU.

The motor driver 276 is a driver which drives the motor 288 in accordance with instructions from the system controller 272. In FIG. 13, the motors disposed in the respective sections in the apparatus are represented by the reference numeral 288. For example, the motor 288 shown in FIG. 13 comprises a motor which drives the drive rollers in the tensioning rollers 34A to 34C in FIG. 1, a motor of the movement mechanism of the solvent removal roller 42, a motor of the movement mechanisms of the transfer roller 36 and the pressurization roller 48, and the like.

The heater driver 278 shown in FIG. 13 is a driver which drives the heater 289 in accordance with instructions from the system controller 272. In FIG. 13, the plurality of heaters which are provided in the inkjet recording apparatus 10 are represented by the reference numeral 289. For instance, the heater 289 shown in FIG. 13 includes the heater of a heating unit 18 shown in FIG. 1, a pre-heater 46, and the like.

The cooler control unit 279 in FIG. 13 is a control unit which controls the temperature of the cooler 20 (see FIG. 1) in accordance with the instructions from the system controller 272.

The print controller 280 has a signal processing function for performing various tasks, compensations, and other types of processing for generating print control signals from the image data stored in the memory 274 in accordance with commands from the system controller 272 so as to supply the generated print data (dot data) to the head driver 284. Prescribed signal processing is carried out in the print controller 280, and the ejection amount and the ejection timing of the ink droplets from the respective print heads 80 are controlled via the head driver 284, on the basis of the print data. By this means, prescribed dot size and dot positions can be achieved.

The print controller 280 is provided with the image buffer memory 282; and image data, parameters, and other data are temporarily stored in the image buffer memory 282 when image data is processed in the print controller 280. The aspect shown in FIG. 13 is one in which the image buffer memory 282 accompanies the print controller 280; however, the memory 274 may also serve as the image buffer memory 282. Also possible is an aspect in which the print controller 280 and the system controller 272 are integrated to form a single processor.

To give a general description of the sequence of processing from image input to print output, image data to be printed is input from an external source via a communications interface 270, and is accumulated in the memory 274. At this stage, RGB image data is stored in the memory 274, for example.

In this inkjet recording apparatus 10, an image which appears to have a continuous tonal graduation to the human eye is formed by changing the droplet ejection density and the dot size of fine dots created by ink (coloring material), and therefore, it is necessary to convert the input digital image into a dot pattern which reproduces the tonal gradations of the image (namely, the light and shade toning of the image) as faithfully as possible. Therefore, original image data (RGB data) stored in the memory 274 is sent to the print controller 280 through the system controller 272, and is converted to the dot data for each ink color by a half-toning technique, using a threshold value matrix, error diffusion, or the like, in the print controller 280.

In other words, the print controller 280 performs processing for converting the input RGB image data into dot data for the four colors of K, C, M and Y. The dot data generated by the print controller 280 in this way is stored in the image buffer memory 282. The primary image formed on the intermediate transfer body 12 must be a mirror image of the secondary image which is to be formed finally on the recording medium 14, taking account of the fact that it is reversed when transferred onto the recording medium. In other words, the drive signals supplied to the heads 22Y, 22M, 22C and 22K are drive signals corresponding to a mirror image, and therefore the input image must be subjected to reversal processing by the print controller 280.

The head driver 284 outputs drive signals for driving the actuators 88 corresponding to the respective nozzles 81 of the heads 80, on the basis of the print data supplied by the print controller 280 (in other words, the dot data stored in the image buffer memory 282). A feedback control system for maintaining constant drive conditions in the head may be included in the head driver 284.

By supplying the drive signals output by the head driver 284 to the print heads 80, ink is ejected from the corresponding nozzles 81. An image (primary image) is formed on the intermediate transfer body 12 by controlling ink ejection from the heads 80 while conveying the intermediate transfer body 12 at a prescribed speed.

Furthermore, the system controller 272 controls the transfer control unit 292 and the treatment liquid application control unit 294, and furthermore, it also controls the operation of the solvent removal unit 24, the first cleaning unit 30 and the second cleaning unit 32, as shown in FIG. 1.

The transfer control unit 292 shown in FIG. 13 controls the temperature and the nip pressure of the transfer roller 36 of the transfer unit 26 and the pressure roller 48 (see FIG. 1). The optimal values for the nip pressure and transfer temperature (target control values) are previously determined for each type of recording medium 14 and each type of ink, and this data is stored in a prescribed memory (for example, a ROM 275) in the form of a data table. When the system controller 272 acquires information about the recording medium 14 being used and the ink being used, on the basis of an input made by an operator, or by automatically reading in information from a prescribed sensor, then the system controller 272 controls the temperature and the nip pressure of the transfer roller 36 and the pressurization roller 48 accordingly, by referring to the data table.

The treatment liquid application control unit 294 shown in FIG. 13 controls the operation of the treatment liquid application unit 16 in accordance with the instructions from the system controller 272. If a liquid application apparatus 100 as shown in FIGS. 7, 8, 10, 11 and 12 is used for the treatment liquid application unit 16, then as shown in FIG. 13, the liquid supply pump 104, the abutment/separation mechanism drive unit 304 of the gravure roller, the gravure roller rotation drive unit 306, and the like, are controlled by the treatment liquid application control unit 294.

In the first embodiment which was described above, after applying an aggregation treatment agent (treatment liquid), the treatment agent is caused to dry so as to form a solid or semi-solid aggregation treatment agent layer, and droplets of ink are then deposited onto this layer. However, a mode is also possible in which the aggregation treatment agent is applied after droplets of ink are deposited on the intermediate transfer body. Below, this mode is described as a second embodiment.

### Second Embodiment

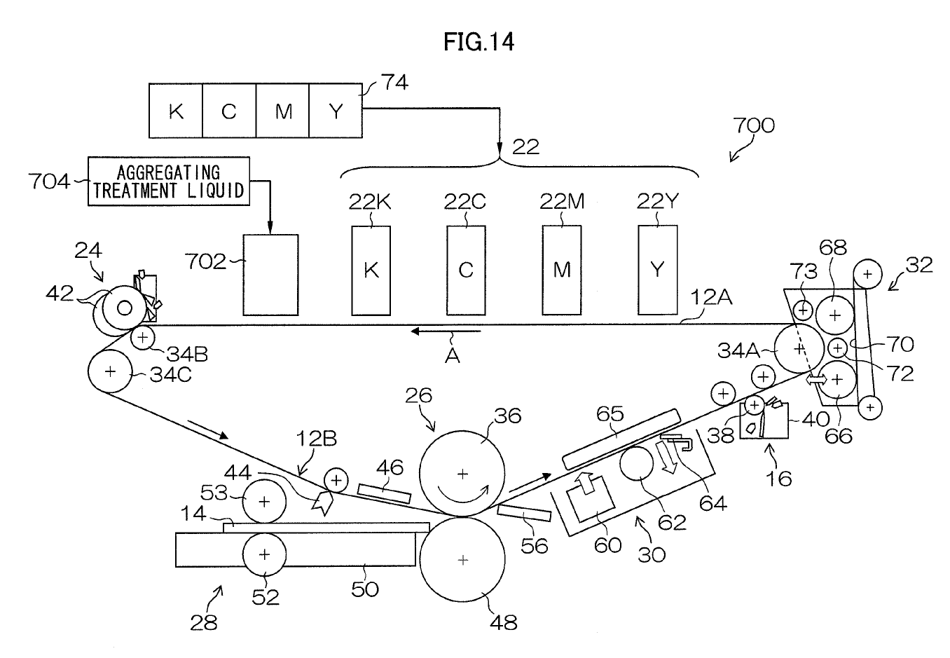

FIG. 14 is a schematic drawing of an inkjet recording apparatus 700 according to a second embodiment. In FIG. 14, elements which are the same as or similar to the composition in FIG. 1 are labeled with the same reference numerals and description thereof is omitted here.

The inkjet recording apparatus 700 shown in FIG. 14 differs from the inkjet recording apparatus 10 shown in FIG. 1 according to the first embodiment, in respect of the undercoating liquid applied by the treatment liquid application unit 16. Moreover, the inkjet recording apparatus 700 differs from the inkjet recording apparatus 10 in that the inkjet recording apparatus 700 is provided with a liquid ejection head (hereinafter, called “aggregation liquid head”) 702 which is arranged on the downstream side of the print unit 22 and deposits an aggregation treatment liquid, instead of the heating unit 18 and cooler 20 in FIG. 1.

In other words, the inkjet recording apparatus 700 shown in the present embodiment employs a three-liquid image forming method, in which a first treatment liquid layer is formed by means of an undercoating liquid (hereinafter, called the “first treatment liquid”) on the intermediate transfer body 12, droplets of ink are ejected into this first treatment liquid layer, and then droplets of an aggregation treatment liquid (hereinafter, called the “second treatment liquid”) which has the function of causing the ink droplets to aggregate are ejected in accordance with the liquid ink droplets in the first treatment liquid layer, thereby causing the coloring material (pigment) in the ink to aggregate and thus forming an ink aggregate.

The first treatment liquid which is applied by the treatment liquid application unit 16 of this inkjet recording apparatus 700 is a liquid which does not have the function of aggregating the ink droplets, even if it makes contact with the ink droplets; for example, a liquid obtained by removing the coloring material (pigment) from the ink liquid used in the print unit 22 can be used as the first treatment liquid. An example of the preparation of the first treatment liquid is shown in Table 5.

TABLE 5

| Material | Weight % |
|---|---|
| Latex LX-2 | 8 |
| Glycerine (made by Wako Pure Chemical Industries Co., Ltd.) | 20 |
| Diethylene glycol (made by Wako Pure Chemical | 10 |
| Industries Co., Ltd.) | |
| Olfine E1010 (made by Nissin Chemical Industry Co., Ltd.) | 1 |
| Deionized water | 61 |

The aggregation treatment liquid (second treatment liquid) ejected from the aggregation liquid head 702 is desirably a treatment liquid which has the function of generating an ink aggregate by causing the pigment (coloring material) and the polymer micro-particles contained in the ink to aggregate by altering the pH of the ink.

The aggregation treatment liquid storing and loading unit 704 shown in FIG. 14 is constituted by a tank which stores the second treatment liquid which is supplied to the treatment liquid head 702. The tank is connected to the treatment liquid head 702 via a prescribed flow channel.

The aggregation liquid head 702 according to the present embodiment uses the same composition as the head disposed in the print unit 22. Provided that it is possible to deposit aggregation treatment liquid by a non-contact method onto the intermediate transfer body 12, the aggregation liquid head 702 may adopt a structure having a reduced droplet ejection density (resolution) compared to the ink heads 22Y, 22M, 22C and 22K, and it may also adopt a method other than an inkjet method, such as a spray method.

Desirably, the component of the second treatment liquid is selected from: polyacrylic acid, acetic acid, glycol acid, malonic acid, malic acid, maleinic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, cumaric acid, thiophene carboxylic acid, nicotinic acid, or derivatives of these compounds, or salts of these, or the like.

A desirable example of the second treatment liquid is a treatment liquid to which a multivalent salt or polyallylamine has been added. These compounds may be used singly, or a combination of two or more of these compounds may be used.

From the viewpoint of the pH aggregating performance with respect to the ink, the second treatment liquid desirably has a pH of 1 through 6, more desirably, a pH of 2 through 5, and particularly desirably, a pH of 3 through 5.

The added amount, in the second treatment liquid, of the compound which causes aggregation of the ink pigment and polymer micro-particles, is desirably not less than 0.01 wt % and not more than 20 wt %, with respect to the total weight of the liquid. If the amount is less than 0.01 wt %, then when the ink comes into contact with the second treatment liquid, the concentration and dispersion do not advance sufficiently, and a sufficient aggregating action on the basis of the pH change may not be produced. If, on the other hand, the amount is more than 20 wt %, then there are concerns over deterioration of the ejection performance from the inkjet head (for example, the occurrence of ejection abnormalities).

Desirably, the second treatment liquid contains water and another organic solvent which is capable of dissolving the additive, in order to prevent blocking of the nozzles of the ejection head (702) due to drying. The water or other organic solvent capable of dissolving the additive includes a moistening agent or a penetrating agent. These solvents can be used independently, or in plural fashion, together with the other additive.

The content of the water and the other organic solvent capable of dissolving the additive should desirably be not more than 60 wt % with respect to the total weight of the second treatment liquid. If the content is more than 60 wt %, then the viscosity of the treatment liquid increases, and the ejection characteristics from the inkjet head may so deteriorate.

It is also possible to include a resin component in the second treatment liquid in order to improve the fixing characteristics and the rub resistance. The resin component may be any resin which would not impair the ejection characteristics from the head and which has stable storage characteristics in cases where the treatment liquid is ejected in the form of droplets by an inkjet method, and it is possible freely to choose a water-soluble resin, resin emulsion, or the like.

The resin component may be an acrylic polymer, a urethane polymer, a polyester polymer, a vinyl polymer, a styrene polymer, or the like. In order to display sufficiently the functions of the material in improving fixing characteristics, it is necessary to add a polymer of relatively high molecular weight, at a high concentration (1 wt % through 20 wt %). However, if it is sought to add the aforementioned materials by dissolving in the liquid, then the viscosity of the liquid increases and the ejection characteristics decline. In order to add a suitable material at a high concentration or to suppress increase in the viscosity, it is effective to add the material in the form of latex. Possible latex materials are, for instance: an alkyl copolymer of acrylic acid, carboxyl-modified SBR (styrene-butadiene latex), SIR (styrene-isoprene latex), MBR (methyl methacrylate-butadiene latex), NBR (acrylonitrile-butadiene latex), or the like.

The glass transition point Tg of the latex has a significant effect during the fixing process, and desirably, it is not lower than 50° C. or not higher than 120° C., in order to achieve both the stability during storage at normal temperature and good transfer characteristics after heating. Moreover, during the process, the minimum film forming temperature MFT also has a significant effect on fixing and in order to achieve suitable fixing at low temperatures, desirably it is 100° C. or lower, and more desirably, 50° C. or lower.

A desirable mode is one where the second treatment liquid contains polymer micro-particles of opposite polarity to the ink, since this further enhances the aggregating properties by causing aggregation of the pigment and polymer micro-particles in the ink. Furthermore, the aggregating properties may be enhanced by including, in the second treatment liquid, a curing agent which corresponds to the polymer micro-particle component contained in the ink, in such a manner that the resin emulsion in the ink composition aggregates and produces a cross-linking or polymerization reaction, after the ink and second treatment liquid have come into contact.

The second treatment liquid may include a surfactant. Desirable examples of a surfactant are: in a hydrocarbon system, an anionic surface active agent, such as a salt of a fatty acid, an alkyl sulfate ester salt, an alkyl benzene sulfonate salt, an alkyl naphthalene sulfonate salt, a dialkyl sulfosuccinate salt, an alkyl phosphate ester salt, a naphthalene sulfonate/formalin condensate, a polyoxyethylene alkyl sulfonate ester salt, or the like; or a non-ionic surface active agent, such as a polyoxyethylene alkyl ether, a polyoxyethylene alkyl aryl ether, a polyoxyethylene fatty acid ester, a sorbitan fatty acid ester, a polyoxyethylene sorbitan fatty acid ester, a polyoxyethylene alkyl amine, a glycerine fatty acid ester, an oxyethylene oxypropylene block copolymer, and the like.

Furthermore, it is also desirable to use SURFYNOLS (Air Products & Chemicals Co. Ltd.), which is an acetylene-based polyoxyethylene oxide surface active agent. Furthermore, an amine oxide type of ampholytic surface active agent, such as N,N-dimethyl-N-alkyl amine oxide, is also desirable. Moreover, the surfactants cited on pages 37 to 38 of Japanese Patent Application Publication No. 59-157636, and the surfactants cited in Research Disclosure No. 308119 (1989), can be used as the surfactant of the second treatment liquid.

Furthermore, it is also possible to use a fluorine (alkyl fluoride) type, or silicone type of surface active agent such as those described in Japanese Patent Application Publication No. 2003-322926, Japanese Patent Application Publication No. 2004-325707, and Japanese Patent Application Publication No. 2004-309806. It is also possible to use a surface tension adjuster of this kind as an anti-foaming agent; and a fluoride or silicone compound, or a chelating agent, such as EDTA, can also be used.

If the surfactant described above is included in the second treatment liquid, then a beneficial effect is obtained in that the surface tension of the second treatment liquid is lowered and the wetting properties on the intermediate transfer body are improved. Desirably, the surface tension of the second treatment liquid is 10 through 50 mN/m, and in the case of application by means of an inkjet method, more desirably, the surface tension of the second treatment liquid is 15 through 45 mN/m from the viewpoint of achieving finer liquid droplets and improving the ejection performance.

Desirably, the viscosity of the second treatment liquid is 1.0 through 20.0 cP, from the viewpoint of depositing by means of an inkjet method. It is also possible to add, to a second treatment liquid, a pH buffering agent, an anti-oxidation agent, an anti-rusting agent, a viscosity adjusting agent, a conducting agent, an ultraviolet light absorbing agent, and the like.

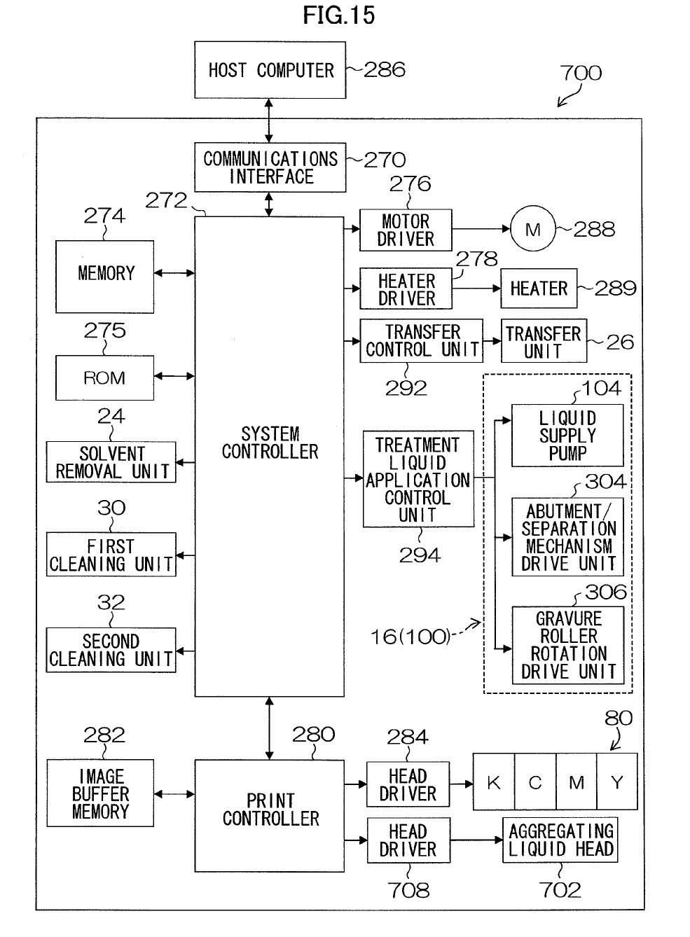

FIG. 15 is a block diagram of the inkjet recording apparatus 700 shown in FIG. 14. In FIG. 15, elements which are the same as or similar to the example in FIG. 13 are labeled with the same reference numerals and description thereof is omitted here.

In the inkjet recording apparatus 700 shown in FIG. 15, an aggregation liquid head 702 and a head driver 706 which drives this head are provided as devices for depositing the aggregation treatment liquid (second treatment liquid). The head driver 706 generates drive signals to be applied to the actuators 88 in the aggregation liquid head 702, on the basis of image data supplied from the print control unit 280, and also comprises drive circuits which drive the actuators 88 by applying the drive signals to the actuators 88. In this way, a desirable mode is one in which a composition for ejecting droplets of aggregation liquid in accordance with the image data is adopted, and droplets of aggregation treatment liquid are ejected selectively onto the positions where droplets of ink have been deposited by the print unit 22, but it is also possible to adopt a mode in which the aggregation liquid is deposited in a uniform fashion by using a spray nozzle.

Furthermore, in the respective embodiments described above, an endless belt is used as the intermediate transfer body, but it is also possible to adopt a mode which uses a drum-shaped intermediate transfer body. In this case, from the viewpoint of the processing characteristics and the thermal control characteristics, it is desirable to use an intermediate transfer body formed by coating a fluorine elastomer onto the surface of a thin aluminum tube which is reinforced by ribs. Furthermore, in the respective embodiments described above, an example was described in which a treatment liquid is applied to an intermediate transfer body and then transferred onto a recording medium, but the liquid application apparatus according to the present invention can also be used in a recording method where a treatment liquid is applied directly to the recording medium without passing via an intermediate transfer body. It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid application apparatus which applies application liquid onto a band-shaped base material that is conveyed continuously, the liquid application apparatus comprising:
an application cylinder which includes an application section and two small diameter sections having a diameter smaller than the application section, the two small diameter sections being arranged so as to interpose the application section, the application section having an upper portion that is in contact with the band-shaped base material and a lower portion at which the application liquid is supplied, the supplied application liquid on the application section being transferred to the band-shaped base material at the upper portion of the application section while the application cylinder is rotated;
a first blade which makes contact with a circumferential surface of the application section of the application cylinder at a contact line, the first blade scraping away an excess of the application liquid on the application section of the application cylinder before the application liquid is transferred to the band-shaped base material; and
a second blade which is in contact with circumferential surfaces of the two small diameter sections of the application cylinder.

2. The liquid application apparatus as defined in claim 1, wherein the application section of the application cylinder includes a gravure roller having a circumferential surface on which a plurality of recess-shaped cells are arranged, the plurality of recess-shaped cells retaining the application liquid that is supplied at the lower portion of the application section.

3. The liquid application apparatus as defined in claim 1, wherein the application section of the application cylinder has a width narrower than the band-shaped base material.

4. The liquid application apparatus as defined in claim 1, wherein the two small diameter sections are arranged so as not to come into contact with the application liquid in a state where the application cylinder is not rotated.

5. The liquid application apparatus as defined in claim 1, wherein the second blade includes a supported section and a gravure roller contact section, the second blade bending at a bending position between the supported section and the gravure roller contact section, the gravure roller contact section of the second blade making contact with the two small diameter sections of the application cylinder, the second blade being arranged so that the bending position of the second blade is at a height not greater than that of an extended line of the contact line between the first blade and the circumferential surface of the application section.

6. The liquid application apparatus as defined in claim 1, further comprising a blade holding body which holds the first and second blades, wherein the first blade has a flexibility lower than the second blade.

7. The liquid application apparatus as defined in claim 1, wherein the application section of the application cylinder has a side face that makes contact with an end of the second blade.

8. The liquid application apparatus as defined in claim 1, further comprising a third blade which is attached to the second blade so as to make contact with a side face of the application section of the application cylinder, the third blade being movable in an axle direction of the application cylinder.

9. The liquid application apparatus as defined in claim 1, further comprising a third blade which is detachably attached to the second blade so as to make contact with a side face of the application section of the application cylinder, the third blade having a flexibility different from that of the second blade.

10. The liquid application apparatus as defined in claim 1, wherein the first blade and the second blade are adjacently arranged to be parallel with each other.

11. An inkjet recording apparatus which records an ink image on a recording medium, the inkjet recording apparatus comprising:
a treatment liquid application device which includes the liquid application apparatus as defined in claim 1, the treatment liquid application device applying treatment liquid that contains an aggregating agent onto an intermediate transfer body forming the band-shaped base material;
an ink ejection device which deposits ink onto the intermediate transfer body on which the treatment liquid has been applied by the treatment liquid application device, the deposited ink being aggregated by the treatment liquid to form the ink image on the intermediate transfer body; and
a transfer device which transfers the ink image on the intermediate transfer body to the recording medium.
